(19) United States
(12) Patent Application Publication
(10) Pub. No.: US 2026/0078251 A1
(43) Pub. Date: Mar. 19, 2026

(54) GROUT COMPOSITION AND METHOD OF MAKING THE GROUT COMPOSITION WITH MIDRIB PARTICULATES AND FIBERS FROM DATE PALM WASTE

(71) Applicant: KING FAHD UNIVERSITY OF PETROLEUM AND MINERALS, Dhahran (SA)

(72) Inventors: Abba Abdulhamid ABUBAKAR, Dhahran (SA); Nahri Syed WASEETUDDIN, Dhahran (SA); Khaled S. AL-ATHEL, Dhahran (SA); Syed Sohail AKHTAR, Dhahran (SA)

(73) Assignee: KING FAHD UNIVERSITY OF PETROLEUM AND MINERALS, Dhahran (SA)

(21) Appl. No.: 18/887,319

(22) Filed: Sep. 17, 2024

(51) Int. Cl. C08L 63/00; C08K 3/36; C08K 5/00; C08K 7/02

(52) U.S. Cl. CPC C08L 63/00; C08K 3/36; C08K 5/0025; C08K 7/02; C08K 2201/003; C08K 2201/004; C08L 2205/16

(57) ABSTRACT

An epoxy grout composition for under-grouting applications includes an epoxy resin and a hardener in a ratio of about one part hardener to about five parts epoxy resin. The grout composition further includes a first filler consisting of a silica sand having a density in a range of about 2000 kg/m³ to about 2300 kg/m³, and a second filler comprising about 2 wt % to about 10 wt % of date palm waste material having a density in a range of 85 kg/m³ to 890 kg/m³. The date palm waste material includes date palm midrib or date palm midrib fibers. The incorporation of date palm waste in a weight fraction of 2% or 5% in the grout compositions results in a significant increase in the compressive and flexural strengths of the epoxy grout compositions.

### STATEMENT REGARDING PRIOR DISCLOSURE BY THE INVENTORS

Aspects of this technology are described in an article “Investigation of epoxy grouts incorporating date palm waste: Mechanical performance analysis”, published in Case Studies in Construction Materials, Volume 20, on May 20, 2024, which is incorporated herein by reference in its entirety.

### STATEMENT OF ACKNOWLEDGEMENT

Support provided by the King Fahd University of Petroleum & Minerals (KFUPM) and the Interdisciplinary Research Center for Advanced Materials (IRC-AM) is gratefully acknowledged.

### BACKGROUND

### Technical Field

The present disclosure is directed to epoxy grout compositions including midrib particulates and fibers of date palm waste, and methods for making the epoxy grout compositions which include midrib particulates and fibers of date palm waste.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Grout is used in construction industries to seal and fill gaps between tiles, walls, and other cavities, such as between crane rails, machine bedding plates, anchors, starter bars, and bridge bearings. Among available grouts, polymer grouts are widely used because of their high load-bearing capacity, resistance to harsh environments, dynamic stability, and fast setting time. Epoxy grouts, a subset of polymer grouts, are made of a combination of epoxy, hardener, and filler. Further, epoxy grouts are used in construction applications such as under-grouting, where the grout material is poured over a wide area to support structures, foundations, machines, and equipment [See: H. Fang, Z. Yu, J. Wang, F. Wang, J. Zhang, J. Chen, Effects of crushed stones on the compression properties of polymer grout materials, Construction and Building Materials 271 (2021); J. Wang, X. Li, C. Wang, C. Zhang, H. Fang, Y. Deng, Quantitative analysis of the representative volume element of polymer grouting materials based on geometric homogenization, Construction and Building Materials 300 (2021)]. The load-bearing capacity of the grout should be high to withstand the loads transferred by the equipment without any damage or failure. However, in some cases, the performance of epoxy grouts can be hampered by the disadvantages of the epoxy itself, such as lower ductility, lower fracture toughness, and lower modulus values [See: N. Saba, M. Jawaid, Epoxy resin based hybrid polymer composites, Hybrid Polymer Composite Materials: Properties and Characterisation (2017); N. Saba, M. Jawaid, O. Y. Alothman, M. T. Paridah, A. Hassan, Recent advances in epoxy resin, natural fiber-reinforced epoxy composites and their applications]. Therefore, improvement in mechanical properties of the epoxy-based grout can be achieved by the addition of various types of fillers and additives [See: A. Gopinath, M. Senthil Kumar, A. Elayaperumal, Experimental Investigations on Mechanical Properties Of Jute Fiber Reinforced Composites with Polyester and Epoxy Resin Matrices, Procedia Engineering 97 (2014)]. Among the additives and fillers, natural fibers are preferred compared to artificial fibers, such as carbon, glass, polyester, etc., due to their abundant availability, lower processing costs, recyclability, and biodegradability.

The use of various types of natural fibers obtained from plant sources as reinforcements for various types of polymer composites and the effect of using such fibers on the mechanical properties of resulting composites have been a topic of research [See: S. Sair, A. Oushabi, A. Kammouni, O. Tanane, Y. Abboud, A. El Bouari, Mechanical and thermal conductivity properties of hemp fiber reinforced polyurethane composites, Case Studies in Construction Materials 8 (2018) 203-212; A. Mellaikhafi, M. Ouakarrouch, A. Benallel, A. Tilioua, M. Ettakni, A. Babaoui, M. Garoum, M. A. Alaoui Hamdi, Characterization and thermal performance assessment of earthen adobes and walls additive with different date palm fibers, Case Studies in Construction Materials 15 (2021) e00693; A. Oushabi, S. Sair, Y. Abboud, O. Tanane, A. E. Bouari, An experimental investigation on morphological, mechanical and thermal properties of date palm particles reinforced polyurethane composites as new ecological insulating materials in building, Case Studies in Construction Materials 7 (2017) 128-137; M. Adamu, M. L. Marouf, Y. E. Ibrahim, O. S. Ahmed, H. Alanazi, A. L. Marouf, Modeling and optimization of the mechanical properties of date fiber reinforced concrete containing silica fume using response surface methodology, Case Studies in Construction Materials 17 (2022) e01633] due to growing need to promote the use of sustainable, reusable, and recyclable materials. Various experiments have further been conducted into the use of natural fibers to make valuable composite materials from epoxy, such as kenaf [See: V. Fiore, G. Di Bella, A. Valenza, The effect of alkaline treatment on mechanical properties of kenaf fibers and their epoxy composites, Composites Part B: Engineering 68 (2015) 14-21; B. F. Yousif A. Shalwan, C. W. Chin, K. C. Ming, Flexural properties of treated and untreated kenaf/epoxy composites, Materials & Design 40 (2012) 378-385], sisal [See: V. P. Arthanarieswaran, A. Kumaravel, M. Kathirselvam, Evaluation of mechanical properties of banana and sisal fiber reinforced epoxy composites: Influence of glass fiber hybridization, Materials & Design 64 (2014) 194-202; P. Haldar, N. Modak, G. Sutradhar, Comparative Evaluation of Mechanical Properties of Sisal-Epoxy Composites With and Without Addition of Aluminium Powder, Materials Today: Proceedings 4 (2017) 3397-3406; A. E. Bekele, H. G. Lemu, M. G. Jiru, Experimental study of physical, chemical and mechanical properties of enset and sisal fibers, Polymer Testing 106 (2022)], jute [See: K. P. Ashik, R. S. Sharma, N. Raghavendra, Evaluation of Tensile, Modal and Fracture Properties of Jute/Epoxy Natural Composites with addition of Silicon Di Oxide as Filler Material, Materials Today: Proceedings 4 (2017) 9586-9591; A. Gopinath, M. Senthil Kumar, A. Elayaperumal, Experimental Investigations on Mechanical Properties Of Jute Fiber Reinforced Composites with Polyester and Epoxy Resin Matrices, Procedia Engineering 97 (2014) 2052-2063.] and coconut shell [See: S. Sajith, V. Arumugam, H. N. Dhakal, Comparison on mechanical properties of lignocellulosic flour epoxy composites prepared by using coconut shell, rice husk and teakwood as fillers, Polymer Testing 58 (2017) 60-69.]

Among the natural fibers, date palm fibers are used in many applications, due to their wide availability and low cost. Processing of date palm trees generates date palm waste, posing substantial environmental and waste disposal challenges. These waste materials encompass components, including petioles, rachises, leaflets, fibrillium, bunches, pedicels, spathes, and thorns. Date palm residues and the various kinds of date palm fibers may serve as promising fillers and reinforcements, particularly in the composite industry, especially in polymer composites [See: N. Benmansour, B. Agoudjil, A. Gherabli, A. Kareche, A. Boudenne, Thermal and mechanical performance of natural mortar reinforced with date palm fibers for use as insulating materials in building, Energy and Buildings 81 (2014) 98-104; W. Abid, S. Magdich, I. B. Mahmoud, K. Medhioub, E. Ammar, Date Palm Wastes Co-composted Product: An Efficient Substrate for Tomato (Solanum lycopercicum L.) Seedling Production, Waste and Biomass Valorization 9 (2018) 45-55]. Research has been performed in the use of date palm fibers (DPF) as fillers for reinforcement in polymer matrices [See: S. Tripathy, J. Dehury, D. Mishra, A Study On the effect of Surface treatment on the Physical and Mechanical properties of date-palm stem fiber embedded epoxy composites, IOP Conference Series: Materials Science and Engineering 115 (2016) 012036; T. Alsaeed, B. F. Yousif, Machinability of glass/date palm fibre epoxy composites, International Journal of Machining and Machinability of Materials (2014) 129-150; L-I. J. of S. T. and Engineering, Effect of Fiber Length on the Mechanical Properties of Coir and Wild Date Palm Reinforced Epoxy Composites, (n.d.). (accessed Oct. 10, 2023); A. Shalwan, B. F. Yousif, Influence of date palm fibre and graphite filler on mechanical and wear characteristics of epoxy composites, Materials & Design 59 (2014) 264-273; M. H. Gheith, M. A. Aziz, W. Ghori, N. Saba, M. Asim, M. Jawaid, O. Y. Alothman, Flexural, thermal and dynamic mechanical properties of date palmfibres reinforced epoxy composites, Journal of Materials Research and Technology 8 (2019) 853-860.]. Research was conducted into incorporating date palm wood powders in low-density polyethylene composites [See: M. A. AlMaadeed, Z. Nógellová, M. Miçuŝik, L Novák, L Krupa, Mechanical, sorption and adhesive properties of composites based on low density polyethylene filled with date palm wood powder, Materials & Design 53 (2014) 29-37; M. A. AlMaadeed, Z. Nógellová, L Janigová, L Krupa, Improved mechanical properties of recycled linear low-density polyethylene composites filled with date palm wood powder, Materials & Design 58 (2014) 209-216.]. This research has reported increased flexural and Young's modulus by adding date palm wood powders. A study [See: A. Oushabi, S. Sair, F. Oudrhiri Hassani, Y. Abboud, O. Tanane, A. El Bouari, The effect of alkali treatment on mechanical, morphological and thermal properties of date palm fibers (DPFs): Study of the interface of DPF-Polyurethane composite, South African Journal of Chemical Engineering 23 (2017) 116-123.] was conducted in using alkali-treated DPFs in a polyurethane matrix (PU). The result indicated an increase in the tensile characteristics of the DPF and the DPF-PU interfacial properties due to improved adhesion.

Explorations into the integration of DPF into polymers containing high-density polyethylene (HDPE) matrices have been conducted. [See: S. Mahdavi, H. Kermanian, A. Varshoei, Comparison of mechanical properties of date palm fiber-polyethylene composite, BioResources 5 (2010) 2391-2403; B. Aldousiri, M. Alajmi, A. Shalwan, Mechanical properties of palmfibre reinforced recycled HDPE, Advances in Materials Science and Engineering 2013 (2013)]. The investigations delve into the influence of DPF derived from distinct parts of the date palm tree, namely the trunk, rachis, and petiole, on the morphological, chemical, and mechanical attributes of DPF/HDPE wood plastic composites [See: S. Mahdavi, H. Kermanian, A. Varshoei, Comparison of mechanical properties of date palm fiber-polyethylene composite, BioResources 5 (2010) 2391-2403]. The results highlighted the variation in composite properties based on the specific tree part used, emphasizing the disparate characteristics of the trunk, rachis, and petiole. Moreover, DPF derived from the petiole exhibited enhanced flexural properties due to its lower lignin content. At the same time, DPF from the rachis displayed the lowest flexural strength, correlating with higher lignin content. Incorporating 30 wt % of petiole based DPF is also recommended for optimizing composite strength. Another research study [See: B. Aldousiri, M. Alajmi, A. Shalwan, Mechanical properties of palm fibre reinforced recycled HDPE, Advances in Materials Science and Engineering 2013 (2013)] was conducted to investigate the enhancement of the mechanical properties of HDPE through a combination of synthetic reinforcements in the form of chopped strand mat (CSM) glass fibers and natural reinforcements represented by untreated short oil date fibers. The results show that a higher weight fraction of both reinforcement types yielded strength values approaching 50 MPa. Moreover, the study indicates the need for further treatment of date palm fibers to improve the tensile properties of the polymer composites. Another study was conducted [See: A. O. Ameh, M. T. Isa, L Sanusi, Effect of particle size and concentration on the mechanical properties of polyester/date palm seed particulate composites, Leonardo Electronic Journal of Practices and Technologies 14 (2015) 65-78.] to explore the utilization of date palm seeds to make reliable polymer composites. The study focused on the impact of different particle sizes (0.5 mm, 2 mm, and 2.8 mm) of date palm seeds on the mechanical performance of unsaturated polyester resin composites. The study demonstrated that incorporating date palm seeds as a form of reinforcement can augment the properties of polyester composites.

Further improvement in the properties of the natural fibers have been achieved by employing various chemical treatment methods on the fiber surfaces to improve adhesion between the fibers and the polymer matrices. Multiple studies have shown that the mechanical performance of composites synthesized with natural fibers depends on the bonding between the natural fibers and the polymer matrices [See: F. G. Torres, M. L. Cubillas, Study of the interfacial properties of natural fibre reinforced polyethylene, Polymer Testing 24 (2005) 694-698; M. F. Rosa, B. sen Chiou, E. S. Medeiros, D. F. Wood, T. G. Williams, L. H. C. Mattoso, W. J. Orts, S. H. Imam, Effect of fiber treatments on tensile and thermal properties of starch/ethylene vinyl alcohol copolymers/coir biocomposites, Bioresource Technology 100 (2009) 5196-5202; A. S. Virk, W. Hall, J. Summerscales, Failure strain as the key design criterion for fracture of natural fibre composites, Composites Science and Technology 70 (2010) 995-999.]. The degree of compatibility between the natural fibers and the epoxy matrix can significantly affect the porosity, moisture absorption stress transfer, and internal strains within the composite material, leading to degradation in mechanical performance. Therefore, using natural fibers in composites is accompanied by specific chemical treatments to improve the compatibility/adhesion between the natural fibers and the polymer matrix material. The chemical treatment method widely used in many studies is the ‘Alkalization’ process, which involves chemical modification of the surface of the natural fibers by treatment with different percentages of NaOH solution followed by a specific immersion duration to improve compatibility with the polymer matrix [See: V. Fiore, G. Di Bella, A. Valenza, The effect of alkaline treatment on mechanical properties of kenaffibers and their epoxy composites, Composites Part B: Engineering 68 (2015) 14-21; A. Oushabi, S. Sair, F. Oudrhiri Hassani, Y. Abboud, O. Tanane, A. El Bouari, The effect of alkali treatment on mechanical, morphological and thermal properties of date palm fibers (DPFs): Study of the interface of DPF-Polyurethane composite, South African Journal of Chemical Engineering 23 (2017) 116-123; T. Alsaeed, B. F. Yousif, H. Ku, The potential of using date palm fibres as reinforcement for polymeric composites, Materials & Design 43 (2013) 177-184; A. M. M. Edeerozey, H. M. Akil, A. B. Azhar, M. L Z. Ariffin, Chemical modification of kenaffibers, Materials Letters 61 (2007) 2023-2025; S. C. Venkateshappa, S. Y. Jayadevappa, P. K W. Puttiah, Mechanical behavior of areca fiber reinforced epoxy composites, Advances in Polymer Technology 31 (2012) 319-330; I. M. De Rosa, J. M. Kenny, M. Maniruzzaman, M. Moniruzzaman, M. Monti, D. Puglia, C. Santulli, F. Sarasini, Effect of chemical treatments on the mechanical and thermal behaviour of okra (Abelmoschus esculentus) fibres, Composites Science and Technology 2 (2011) 246-254]. An alternative chemical treatment approach known as ‘hornification’ involves wet-drying cycles, where DPFs undergo initial drying in an oven for a specified duration, followed by immersion in water. This technique eliminates moisture from the DPFs before incorporating them into composites. The hornification treatment has been observed to enhance the stability, resistance to moisture absorption, and overall durability of natural fiber-polymer composites, as documented in studies [See: J. E. M. Ballesteros, V. dos Santos, G. Mármol, M. Frías, J. Fiorelli, Potential of the hornification treatment on eucalyptus and pine fibers for fiber-cement applications, Cellulose 24 (2017) 2275-2286; J. Claramunt, M. Ardanuy, J. A. Garcia-Hortal, R. D. T. Filho, The hornification of vegetable fibers to improve the durability of cement mortar composites, Cement and Concrete Composites 33 (2011) 586-595; A. Akhzeroun, A. Semcha, A. Bezazi, H. Boumediri, P. N. B. Reis, F. Scarpa, Development and characterization of a new sustainable composite reinforced with date palm stems for rehabilitation and reconstruction of earthen built heritage, Composite Structures 316 (2023) 117015.].

Research has been conducted to examine the mechanical properties of epoxy-based polymer composites utilizing treated and untreated DPF derived from date palm waste to replace conventional fillers. However, this research relied on experimental methods and was confined to testing few experimental samples without practical application integration. As a result, moving from laboratory-scale development to practical industrial production of such epoxy grout composites has received limited attention in existing literature. Furthermore, random experimental observations rather than computational material design have largely guided the selection of DPF filler characteristics, such as volume fraction, shape, size, and surface morphology. Using dried date palm midrib waste without chemical treatment or excessive processing will simplify the scalability of grout specimen preparation for industrial scale under-grouting. This scalability is crucial in light of the increasing emphasis on sustainability practices and the necessity for providing cost-effective solutions in various process industries.

ID202300854S describes a laminated decking tile product using palm frond waste. The decking tile product includes a matrix of epoxy resin and a reinforcement of pieces of palm midrib. Each tile is assembled by pouring the epoxy resin over hand laid pieces of palm midribs, and hot pressing. However, the tile is not a grout composition having date palm pieces of 1 mm long segments, hardener, epoxy resin and silica sand.

US20240076238A1 describes a raw clay matrix made of cement, 30 wt % clay and 15 wt % of cement and additives, such as sand, date palm oil and oil palm fibers. However, this reference does not mention a grout composition made with epoxy resin and date palm midribs.

WO2015076665A1 describes a grout coating formulation in a ratio of 1.2 water to cement, which is heated and oil palm shell aggregates in the size of 2 to 10 mm are added. Sand and superplasticizer are added. The ratio of sand to oil palm shell is about 3:1. However, this reference discloses a lightweight cement, and the grout coating does not appear to be the final product. Further, the grout coating does not include the epoxy or the sand.

US20220049070A1 describes a composite building product including a low dust filler, which includes a filler material, a hardener and a thermoset resin, which can be epoxy. The low dust filler may be sand or silica. However, this reference does not mention a grout composition including date palm waste as filler.

U.S. Pat. No. 11/958,775B2 describes a grout composition including an acrylic polymer binder with a microfiber filler. The grout is an epoxy grout and the fillers include cellulose and sand. However, date palm waste is not mentioned as a filler.

There is a need for the efficient use of date palm midribs and midrib fibers to formulate epoxy grout composites with hybrid fillers (DPF waste and silica sand) which is explicitly designed for under-grouting applications. Accordingly, it is an object of the present disclosure to use dried date palm midrib waste without chemical treatment or excessive processing to simplify the scalability of grout specimen preparation for industrial scale under-grouting. Further, it is an object of the present disclosure to provide epoxy grout compositions comprising date palm waste for compression-based applications which are durable, sustainable, environment friendly and have high scalability.

### SUMMARY

In an exemplary embodiment, a grout composition is described. The grout composition includes an epoxy resin, a hardener in a ratio of about one part hardener to about five parts epoxy resin, a first filler consisting of a silica sand having a density in a range of about 2000 kg/m³ to about 2300 kg/m³, and a second filler comprising weight fraction W_{f} about 2 wt % to about 10 wt % of date palm waste material having a density in a range of 85 kg/m³ to 890 kg/m³, wherein wt % is the ratio of a weight of the second filler to a total weight of the grout composition.

In another exemplary embodiment, a method of making a grout composition is described. The method includes compounding, with a stirrer, a base composition by mixing an epoxy resin in a weight fraction of about 11.9 wt %, a hardener in a ratio of about one part hardener to about five parts epoxy resin, and a first filler consisting of a silica sand having a density in a range of about 2000 kg/m³ to about 2300 kg/m³; and mixing, with the stirrer, a second filler comprising a weight fraction W_{f} of about 2 wt % to about 10 wt % of date palm waste material having a density in a range comprising 85 kg/m³ to 890 kg/m³ into the base composition, where the date palm waste material is composed of one of date palm midrib particulates in a weight fraction W_{f} of about 2 wt %, date palm midrib particulates in a weight fraction W_{f} of about 5 wt %, date palm midrib fibers in a weight fraction W_{f} of about 2 wt %, and date palm midrib fibers in a weight fraction W_{f} of about 5 wt %, wherein wt % is a ratio of a weight of the second filler to a total weight of the grout composition.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of making a grout composition, according to certain embodiments.

FIG. 2A shows a representative volume element (RVE) model for a grout composition with 2% of 5 mm diameter date palm midrib, according to certain embodiments.

FIG. 2B shows a RVE model for a grout composition with 5% of 5 mm diameter date palm midrib, according to certain embodiments.

FIG. 2C shows a RVE model for a grout composition with 10% of 5 mm diameter date palm midrib, according to certain embodiments.

FIG. 2D shows a RVE model for a grout composition with 2% of date palm midrib fiber with average fiber diameters of 0.1 mm, according to certain embodiments.

FIG. 2E shows a RVE model for a grout composition with 5% of date palm midrib fiber with average fiber diameters of 0.1 mm, according to certain embodiments.

FIG. 2F shows a RVE model for a grout composition with 10% of date palm midrib fiber with average fiber diameters of 0.1 mm, according to certain embodiments.

FIG. 3A shows date palm midribs used in epoxy date palm (EDP) composites, according to certain embodiments.

FIG. 3B shows date palm midrib fibers used in epoxy fiber date palm (EFDP) composites, according to certain embodiments.

FIG. 4 is a graphical representation showing particle size comparison between the date palm midribs, midrib fibers, and the silica sand, according to certain embodiments.

FIG. 5 is a schematic flow chart of a research methodology depicting an experimental approach used to make the grout composition, according to certain embodiments.

FIG. 6A shows testing of the grout composition under flexure, according to certain embodiments.

FIG. 6B shows testing of the grout composition under compression, according to certain embodiments.

FIG. 7A is a graphical representation showing compressive strength evolution of epoxy grout containing date palm midribs, according to certain embodiments.

FIG. 7B is a graphical representation showing compressive strength evolution of epoxy grout containing midrib fibers, according to certain embodiments.

FIG. 8A is a graphical representation showing stress-strain behaviour of EDP specimens under compression after a curing period of 28 days, according to certain embodiments.

FIG. 8B is a graphical representation showing stress-strain behaviour of EFDP specimens under compression after a curing period of 28 days, according to certain embodiments.

FIG. 9A shows distribution of maximum principal stress of EDP specimen under compression after a curing period of 28 days, according to certain embodiments.

FIG. 9B shows distribution of maximum principal stress of EFDP specimen under compression after a curing period of 28 days, according to certain embodiments.

FIG. 9C shows distribution of safety factor (SF) of EDP specimen under compression after a curing period of 28 days, according to certain embodiments.

FIG. 9D shows distribution of SF of EFDP specimen under compression after a curing period of 28 days, according to certain embodiments.

FIG. 10A shows failure characteristics of flexural samples of EDP, according to certain embodiments.

FIG. 10B shows failure characteristics of flexural samples of EFDP, according to certain embodiments.

FIG. 11A is a graphical representation showing stress-strain characteristics of grout specimens with date palm midribs under flexure, according to certain embodiments.

FIG. 11B is a graphical representation showing stress-strain characteristics of grout specimens with midrib fibers under flexure, according to certain embodiments.

FIG. 12 shows scanning electron microscopy (SEM) image of the date palm fiber at scales of 300 μm, 50 μm, and 30 μm, according to certain embodiments.

FIG. 13A shows SEM images of reference epoxy, according to certain embodiments.

FIG. 13B shows SEM images of EFDP2, according to certain embodiments.

FIG. 13C shows SEM images of EFDP10, according to certain embodiments.

FIG. 14A shows x-ray diffraction analysis (XRD) patterns of date palm waste, according to certain embodiments.

FIG. 14B shows XRD patterns of silica sand, according to certain embodiments.

FIG. 15A is a graphical representation showing comparison of compressive strength from experiments and rule of mixtures relation for fiber epoxy grout composite, according to certain embodiments.

FIG. 15B is a graphical representation showing comparison of compressive strength from experiments and rule of mixtures relation for particle-reinforced epoxy grout composite, according to certain embodiments.

FIG. 16A is an optical microscopy image showing distribution of date palm midribs within epoxy matrix of the EDP specimen, according to certain embodiments.

FIG. 16B is an optical microscopy image showing midribs cracks under compression loading, according to certain embodiments.

FIG. 16C is an optical microscopy image showing crack propagation along the edges of midribs, according to certain embodiments.

FIG. 16D is an optical microscopy image showing adhesion between epoxy matrix and midrib under compression loading, according to certain embodiments.

FIG. 17A is an optical microscopy image showing date palm midribs fibers in the epoxy grout of the EFDP2 specimen, according to certain embodiments.

FIG. 17B is an optical microscopy image showing voids/gaps within the matrix as the midrib fibers increases from 2% to 10% in the EFDP specimen, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, “composite” refers to a material composed of two or more components in a way that the material possesses different physical or chemical properties than the original components.

As used herein, “polymer” refers to natural or synthetic macromolecules composed of multiple smaller units called monomers.

As used herein, “hardener” refers to material, usually liquid, that is added to a polymer during the curing process to obtain a strong, solid structure.

As used herein, “filler” refers to materials used along with hardener in grout compositions to enhance the mechanical properties of the grout.

As used herein, “particle size” may be considered the lengths or longest dimensions of a particle.

As used herein, “weight fraction” is the ratio of the weight of one component of a composition to the total weight of the composition.

As used herein, “wt %” of a component is based on the total weight of the formulation or composition in which the component is included. In an example, if a particular element or component in a composition or article is said to have 5 wt %, it is understood that this percentage is in relation to a total compositional percentage of 100%.

Aspects of this disclosure are directed to grout compositions comprising date palm waste for under-grouting heavy machinery and equipment in industries. Three kinds of epoxy grouts having a same ratio of resin to hardener but with different substitutions of silica sand with date palm midrib waste were made. The microstructure and mechanical properties of the synthesized epoxy grout composites containing varying percentages (2%, 5%, and 10%) of date palm waste, specifically comprising midribs and midrib fibers, are assessed. The results show that using midrib fibers resulted in lower mechanical performance of the grout composite than when date palm midribs were used. Moreover, as the amount of date palm waste increases, the mechanical performance of grout specimens decreases. Except for the grout composite containing 10% midrib fiber, the synthesized epoxy grout composites incorporating date palm midrib waste are more durable and sustainable than the benchmark grout material specified for foundation and heavy machinery applications. The absence of chemical treatments and specialized facilities simplifies the scalability of grout specimen preparation from laboratory to industrial scale.

According to an aspect of the present disclosure, the grout composition includes at least one epoxy resin, at least one hardener, a first filler, and a second filler. In one aspect, the epoxy resin can be any polymer having one or more epoxide groups. Any epoxy resin capable of being cross-linked to curing agents or hardeners to provide a hard, robust solid can be used herein. The epoxy resin may have aliphatic, cycloaliphatic, or aromatic groups and may have substitutions with polyols, aliphatic alcohols, dicarboxylic acids, ethers, polyethers, etc. Commonly used epoxy resins are the ones based on glycidyl groups. For example, the epoxy resins based on epoxy monomers derived from diols or polyols are glycidyl ether resins, and those derived from dicarboxylic acids are epoxy ester resins. Another group of commonly used epoxy resins is bisphenol-based epoxy resins. The preferred epoxy resins include bisphenol A diglycidyl ether or bisphenol F diglycidyl ether. Novolaks formed of phenol and formaldehyde may also be used to prepare epoxy resins with glycidyl groups. In some aspects, epoxyphenol novolak or epoxycresol novolak may be used. Epoxy resins are cured with hardeners that impart the resins enhanced mechanical and chemical resistance, strength, and durability. The curing process involves cross-linking the epoxy resins with the hardeners, wherein the hardeners may be selected from a group consisting of polyfunctional amines, amides, phenols, anhydrides, thiols, and the like. In one aspect, the epoxy resin may be curated with at least one hardener, which may be polyamine. Polyamines may be aliphatic, cycloaliphatic, or aromatic amines. In some aspects, the polyamines may have 2, 3, 4, or more than 4 amine groups. According to the present disclosure, the polyamines may be selected from aliphatic and cycloaliphatic amines. In some aspects, polyphenols, primary and secondary thiols may be used as hardeners to curate epoxy resins. The ratio of the hardener to the epoxy resin is important for properly curing the resin. In an aspect, the ratio of the hardener to the epoxy resin may vary from about 1 part hardener to about 2, 3, 4, or 5 parts epoxy resin depending on the type of hardener used and the properties required in the cured resin. In some aspects, the hardener may be added to the epoxy resin in a ratio of about 1 part hardener to about 5 parts epoxy resin (1:5). The grout composition of the present disclosure further includes a first filler. The first filler consists of an inorganic filler. In some aspects, the inorganic filler is a mineral filler. Suitable mineral fillers include silica sand or sands containing silica such as quartz, regular sand or feldspathic sand, alumina, bentonite, limestone, metal sulfates, metal hydroxides or metal carbonates. In some aspects, the first filler includes at least one inorganic filler. In some aspects, the first filler may comprise a mixture of two or more inorganic fillers. According to the present disclosure, the first filler is silica sand.

The first filler is preferably selected based on the density of the mineral particles. A high-density filler results in a less porous composite, leading to a composite with higher compressive strength. In an aspect, the first filler may have a density of about 2000 kg/m³ to about 2300 kg/m³. In some aspects, the first filler may have a density of about 2020 kg/m³, about 2040 kg/m³, about 2060 kg/m³, about 2080 kg/m³, about 2100 kg/m³, about 2120 kg/m³, about 2140 kg/m³, about 2160 kg/m³, about 2180 kg/m³, about 2200 kg/m³, about 2220 kg/m³, about 2240 kg/m³, about 2260 kg/m³, about 2280 kg/m³. According to the present disclosure, the first filler, the silica sand, has a density of about 2120 kg/m³. The first filler may also be selected based on the particle size distribution of the filler material. Particle size distribution defines the relative number of particles present according to their sizes which affects the material properties of the grout composites. The first filler may have a mixture of fine, medium, and coarse particles of varying particle sizes. Accordingly, in some aspects, the first filler may have a particle size distribution ranging from 75 microns to 6.3 mm. For example, the first filler may have fine particles ranging from 75 to 90 microns, medium particles ranging from 100 to 500 microns, and coarse particles with particle sizes ranging from 1 to 5 mm. The particle size distribution and the particle sizes of the filler material can be obtained from sieve analysis. The grout composition further includes a second filler, an organic filler, preferably obtained from a waste material. The present disclosure provides grout composites comprising date palm wastes. Date palm waste is biomass waste obtained from date palm trees. It is predominantly obtained from the processing of date palm trees and their parts, including their trunks, rachis, petioles, and fruits, by industries for various purposes. The date palm biowaste is usually used as animal feed or thrown away in large quantities. The present disclosure provides a method of utilizing this waste to produce grout compositions, making the present disclosure cost-effective and environmentally friendly. This date waste can be obtained from any date processing industry, or the waste generated by the date palm trees naturally. The date waste used in the present disclosure is incorporated without chemical treatment or excessive processing. Chemical processing of fibers may include permanganate treatment, chemical synthesis, stretching, singeing and dew retting, and none of these chemical processing methods are used in the present disclosure to produce the epoxy grout compositions described.

In some aspects, the second filler of the grout composition includes date palm waste, which may include date palm midribs or date palm midrib fibers. The date palm midribs and date palm fibers can be obtained from palm trees at any stage during the palm tree lifecycle, but it is preferred to obtain palm midribs once the date palm tree has reached the end of the life cycle. In some aspects, the date palm midribs, after obtaining, may be dried for a sufficient period such that the moisture content is less than 30%, less than 25%, less than 20%, less than 15%, less than 10%, preferably less than 10%. In some aspects, the date palm midribs may be chopped to a length of about 10 mm, about 9 mm, about 8 mm, about 7 mm, about 6 mm, about 5 mm, preferably 4 mm, about 3 mm, about 2 mm, preferably about 1 mm. Chopping may be done using methods including cutting, blending, grinding, and the like. In some aspects, the date palm midribs may be chopped to a suitable length as described earlier and then dried to remove moisture. In some aspects, the date palm midribs may be further processed by mechanical/chemical treatment to obtain epoxy date palm/epoxy fiber date palm. In a preferred aspect, the date palm midribs are processed without any chemical treatment.

The second filler may comprise date palm waste in a weight fraction W_{f} of about 2 wt % to about 10 wt % of the grout composition, and the amount of the first filler may be adjusted based on the weight fraction W_{f} of the second filler. In some aspects, the second filler in the grout composition may be present in an amount of about 2 wt %, about 3 wt %, about 4 wt %, about 5 wt %, about 6 wt %, about 7 wt %, about 8 wt %, about 9 wt % or about 10 wt % based on the total weight of the grout composition. The preferred amount for the date palm waste in the total filler material may be about 2 wt % based on the total weight of the grout composition. In one aspect, the date palm waste may be present in an amount of about 5 wt % based on the total weight of the grout composition. In another aspect, the date palm waste may be present in an amount of about 10 wt % based on the total weight of the grout composition.

In one aspect, the density of the date palm waste material is in a range of 85 kg/m³ to 890 kg/m³. In another aspect, the density of the date palm waste material is in a range of 135 kg/m³ to 840 kg/m³. In some aspects, the density of the date palm waste material is in a range of 185 kg/m³ to 790 kg/m³, preferably in a range of 235 kg/m³ to 740 kg/m³, in a range of 285 kg/m³ to 690 kg/m³, in a range of 335 kg/m³ to 640 kg/m³, in a range of 385 kg/m³ to 590 kg/m³, in a range of 435 kg/m³ to 540 kg/m³, in a range of 485 kg/m³ to 490 kg/m³. In one aspect, the density of the date palm waste material is in a range of 860 kg/m³ to 880 kg/m³. In another aspect, the density of the date palm waste material is in a range of 870 kg/m³ to 880 kg/m³. In an aspect, the density of the date palm waste material is about 871 kg/m³, about 872 kg/m³, about 873 kg/m³, about 874 kg/m³, about 876 kg/m³, about 877 kg/m³, about 877 kg/m³ and is preferably 875 kg/m³.

In some aspects, the date palm waste of the second filler includes date palm midrib particulates. According to the disclosure, the particulates may be spherical. In such case, the midrib particulates may have an average diameter varying between 1 to 5 mm. In some aspects, the date palm midrib particulates may have an average diameter of about 2 mm, about 3 mm, or about 4 mm. According to the present disclosure, the date palm midrib particulates have an average diameter of about 5 mm.

In some aspects, the date palm waste of the second filler includes date palm midrib fibers, which may be spherical or cylindrical. Midrib fibers of smaller sizes adhere more strongly to the epoxy matrix, resulting in a stronger bond between the epoxy matrix and the midrib fibers. Accordingly, the midrib fibers may have an average diameter of 0.1 mm or less. In an example, the date palm midrib fibers may have an average diameter of about 0.095 mm. In another example, the date palm midrib fibers have an average diameter of about 0.1 mm.

In some aspects, the present disclosure provides for a grout composition comprising the epoxy resin in a weight fraction (Wₑ) of about 11.9 wt %, the hardener in a weight fraction (Wₕ) of about 2.3 wt %, silica sand as the first filler in a weight fraction (Wₛ) of about 83.3 wt % and date palm midrib particulates as the second filler in a weight fraction (W_{f}) of about 2 wt %.

In some aspects, the present disclosure provides a grout composition comprising the epoxy resin in a weight fraction (Wₑ) of about 11.9 wt %, the hardener in a weight fraction (Wₕ) of about 2.3 wt %, silica sand as the first filler in a weight fraction (Wₛ) of about 80.75 wt % and date palm midrib particulates as the second filler in a weight fraction (W_{f}) of about 5 wt %.

In some aspects, grout compositions include date palm midrib fibers as the second filler in a weight fraction (W_{f}) of about 2 wt %. Such compositions further include epoxy resin in a weight fraction (Wₑ) of about 11.9 wt %, the hardener in a weight fraction (Wₕ) of about 2.3 wt %, and silica sand as the first filler in a weight fraction (Wₛ) of about 83.3 wt %.

In some aspects, the grout compositions include the epoxy resin in a weight fraction (Wₑ) of about 11.9 wt %, the hardener in a weight fraction (Wₕ) of about 2.3 wt %, silica sand as the first filler in a weight fraction (Wₛ) of about 80.75 wt % and date palm midrib fibers as the second filler in a weight fraction (W_{f}) of about 5 wt %. The grout compositions may have varying compressive strengths (σ_{c}) and flexural strengths depending on the weight fraction of the date palm waste in the compositions. The compressive and flexural strengths may also differ based on the type of date palm waste in the compositions. Accordingly, the date palm midrib particulates and midrib fibers impart different compressive and flexural strengths to the compositions. The compressive strength of the grout composites can be calculated according to the following equations where the second filler includes date palm midrib particulates and date palm midrib fibers.

$${σ}_{c} = {σ}_{m} {W}_{m} \pm {σ}_{f} {W}_{f} / ( α + ( {W}_{f} - 1 ) β ) ,$$

where σₘ is the compressive strength of a matrix of the epoxy, the hardener and the silica sand, Wₘ is a weight fraction of the matrix, W_{f} is a weight fraction of the date palm midrib particulates, α=2, β=0.1, and σ_{f} is a compressive strength of the date palm midrib particulates; and

$${σ}_{c} = {σ}_{m} {W}_{m} \pm ( ( 1 - Lc ) / L ) {σ}_{f} {W}_{f}$$

where σₘ is a compressive strength of a matrix of the epoxy, hardener and silica sand, Wₘ is a weight fraction of the matrix, W_{f} is a weight fraction of the date palm midrib fibers, α=2, β=0.1, σ_{f} is a compressive strength of the date palm midrib fibers,

$${L}_{c} = \frac{d}{2 τ} {σ}_{c - filler}$$

is a characteristic length of fiber, L is an average length of the date palm midrib fibers, d is an average diameter of the date palm midrib fibers, and i is a shear strength of an interface of the matrix with the date palm midrib fibers.

Further, the mechanical strength of the grout composition is largely affected by the curing time of the composite. The curing time may vary from at least 1 day to 1 month or more. In the present disclosure, the curing of the composites was carried out for 1, 7, and 28 days and it was found that the mechanical performance including the compressive strength and the flexural strength of the composites enhanced by 20-40% after a curing time of 7 days and the strengths increased further when the composites were cured for 28 days. The compressive strength for the composites comprising midrib particulates with respect to the curing time in days t is given by:

$${σ}_{c} = 0.9 \; 01 t - 1.4 \; 41 {W}_{f} + 82.2676 , and {σ}_{c} = 0.404 t - 7.7 \; 60 {W}_{f} + 110.042$$

for date palm midrib fibers.

The compressive strength of the grout composition is about 105.3 MPa and about 102.4 MPa for compositions including the date palm midrib particulates in a weight fraction of about 2 wt % and about 5 wt %, respectively, after curing for 28 days. Flexural strength is the measure of the bending strength of a composite. The flexural strengths of grout compositions comprising date palm midrib particulates in a weight fraction of about 2 wt % and about 5 wt % are found to be about 30.78 MPa and about 26.14 MPa, respectively.

For compositions comprising date palm midrib fibers, the compressive strengths of composites with midrib fibers in a weight fraction of about 2 wt % and about 5 wt % are found to be about 106.10 MPa and about 88.10 MPa, respectively. In some aspects, the flexural strengths of compositions comprising midrib fibers in a weight fraction of about 2 wt % and about 5 wt % are found to be about 29.45 MPa and about 21.26 MPa, respectively. A curing time of 28 days was considered to obtain the compressive and flexural strength values for all kinds of epoxy grout compositions of the present disclosure.

Additionally, the elastic modulus (E_{c}) for testing the stiffness of the grout composites was calculated using E_{c}=EₘVₘ+E_{f}V_{f}, where Eₘ is an elastic modulus of a matrix of the epoxy, hardener and silica sand, Vₘ is a volume fraction of the matrix of the epoxy, hardener and silica sand, E_{f} is an elastic modulus of the date palm midrib fibers and V_{f} is a volume fraction of the date palm midrib fibers. The elastic modulus values decrease with the increase in the content of the date palm waste. Accordingly, the weight fractions of 2 wt % and 5 wt % of both the midrib particulates and the midrib fibers are considered most appropriate for grout compositions having higher mechanical strength, durability and sustainability.

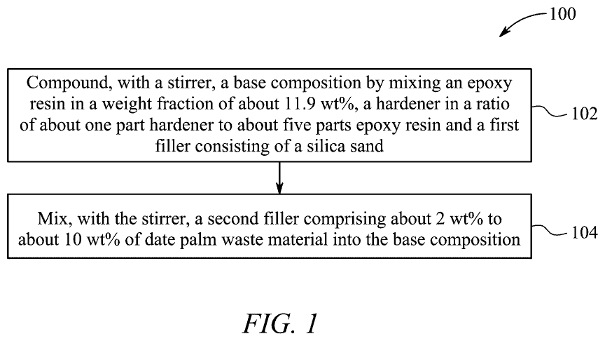

Referring to FIG. 1, a schematic flow chart of a method 100 for making the grout composition is illustrated, according to an aspect of the present disclosure. The order in which the method 100 is described is not intended to be construed as a limitation, and any number of the described method steps can be combined to implement the method 100. Additionally, individual steps may be removed or skipped from the method 100 without departing from the spirit and scope of the present disclosure.

At step 102, the method 100 includes preparing a base composition by mixing the epoxy resin, at least one hardener in a ratio of about one part hardener to about five parts epoxy resin, and the first filler, followed by compounding the composition with a stirrer. The epoxy resin can be any polymer having one or more epoxide groups. The epoxy resin may have aliphatic, cycloaliphatic, or aromatic groups and may have substitutions with polyols, aliphatic alcohols, dicarboxylic acids, ethers, polyethers, etc. Commonly used epoxy resins are the ones based on glycidyl groups, bisphenol-based epoxy resins (bisphenol A diglycidyl ether or bisphenol F diglycidyl ether) or Novolaks. The hardeners may be selected from a group of polyfunctional amines, amides, phenols, anhydrides, thiols, and the like. In one aspect, the epoxy resin may be curated with at least one hardener, which may be polyamine. Polyamines may be aliphatic, cycloaliphatic, or aromatic amines. In some aspects, the polyamines may have 2, 3, 4, or more than 4 amine groups. According to the present disclosure, the polyamines may be selected from aliphatic and cycloaliphatic amines. In some aspects, polyphenols, primary and secondary thiols may be used as hardeners to curate epoxy resins.

The prepared composition is mixed with the second filler, at step 104, and stirred well to obtain the final grout composition. The first filler is preferably a silica sand and the second filler may be selected from date palm midrib particulates in a weight fraction of about 2 wt %, date palm midrib particulates in a weight fraction W_{f} of about 5 wt %, date palm midrib fibers in a weight fraction W_{f} of about 2 wt %, or date palm midrib fibers in a weight fraction W_{f} of about 5 wt %.

The present disclosure reduces waste, minimizes environmental impact by diverting waste from landfills, and yields grout mixtures with satisfactory mechanical performance. The absence of chemical treatments simplifies the scalability of grout specimen preparation from laboratory to industrial scale. This scalability, achieved with minimal equipment and without specialized facilities, promises a cost-effective solution, significantly reducing the logistical and financial resources typically required for large-scale epoxy grouting of machine bases and support structures. The maximum grout thickness applicable for the grout application is 150 mm. However, the actual grout thickness will depend on the type of supporting structure, application area, and construction site conditions.

### EXAMPLES

The following examples demonstrate epoxy grout compositions and the method 100 for preparation of the compositions according to the disclosure. The examples are provided solely for illustration and are not to be construed as limitations of the present disclosure, as many variations thereof are possible without departing from the spirit and scope of the present disclosure.

### Example 1: Computational Material Design

Prior to composite synthesis and development, the epoxy composite's effective elastic modulus and strength response are computationally analyzed utilizing a combination of rule-of-mixture theories, homogenization, and FEA. In computational homogenization, specific boundary conditions are applied to representative volume elements (RVEs) to create an average strain (i.e.,

$$\overline{{ε}_{i j}} = \frac{1}{\vert {V}_{R V E} \vert} {\int }_{{V}_{RVE}} {ε}_{i j} d {V}_{RVE} , {ε}_{i j}$$

is local strain tensor and |V_{RVE}| is total RVE volume) in the presence of displacement or an average stress (i.e.,

$$\overline{{σ}_{i j}} = \frac{1}{\vert {V}_{RVE} \vert} {\int }_{{V}_{RVE}} {σ}_{i j} {dV}_{RVE} , {ε}_{i j}$$

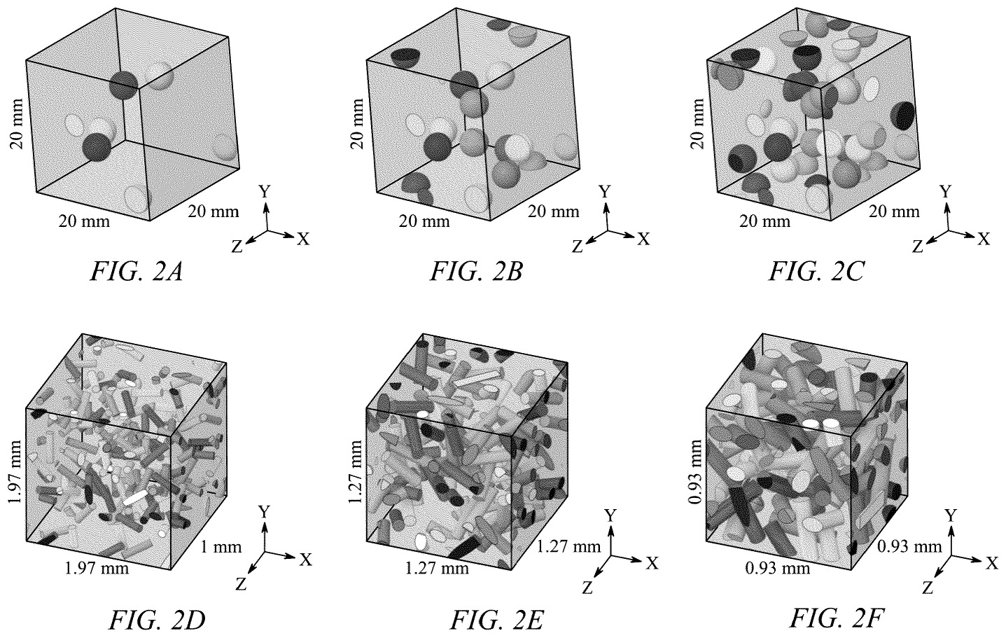

is local strain tensor and |V_{RVE}| is total RVE volume) in the presence of traction. Subsequently, the average strain and average stresses are employed to calculate the effective elastic modulus of the material through Hooke's law, σ̅ᵢⱼ=C̅ᵢⱼₖₗε̅ₖₗ, where Cₜⱼₖₗ is an effective stiffness tensor. The computational homogenization system, which places filler particles or fibers using the random placement algorithm, is implemented using the ANSYS materials designer module [See: Ansys, Ansys Material Designer User's Guide, Ansys, Inc., 2018, incorporated herein by reference in its entirety.] As input, this module requires the density and elastic properties of the matrix (i.e., epoxy with silica sand having p=2120 kg/m³, E=13.98 GPa, v=0.27) and filler materials (i.e., date palm midrib particle or short fiber with p 878 kg/m³, E=5.00 GPa, v=0.25), volume fractions, average filler particle size, and representative RVE geometry, estimated from preliminary tests and literature data [See: Date Palm Fiber Composites, Date Palm Fiber Composites (2020), incorporated herein by reference in its entirety.]. The RVE size must be optimized in relation to the filler volume fraction and particle size since it is the lowest material volume needed to capture the macroscopic response of the composite completely. Before applying the designer module in the present disclosure, the following assumptions were considered: i) the date palm midribs are spherical, ii) the date palm midrib short fibers are cylindrical, and iii) the particle sizes chosen for the waste materials correspond to average particle sizes obtained from the sieve analysis for the waste materials. Based on the assumptions mentioned earlier and initial computational studies, RVE geometries are optimized concerning the essential material parameters, with the representative geometries provided in FIGS. 2A to 2F. FIG. 2A, FIG. 2B, and FIG. 2C show RVE models for the grout composition with 2%, 5%, and 10%, respectively, of 5 mm diameter date palm midrib. Similarly, FIG. 2D, FIG. 2E, and FIG. 2F show RVE models for the grout composition with 2%, 5%, 10%, respectively, of the date palm midrib fiber with average fiber diameters of 0.1 mm.

In order to determine the response of the RVEs to compressive loads, which is a common application requirement for under-grouting heavy machinery and equipment, a structural analysis was employed using the ANSYS static-structural module and the Columb-Mohr (CM) material criteria. In soil and rock mechanics, the CM theory is frequently used to predict the failure of porous rock, wood and brittle concrete structures in which significant variations between compressive and tensile strength are noted. While the ANSYS workbench automatically estimates other parameters that determine the CM failure envelope, such as shear strength, friction angle, and cohesiveness, the software package requires that the nominal tensile and compressive strength values are specified for the matrix and filler phase. Moreover, due to software limitation that restricts defining multiple phases and irregular void shapes, the porosity that evolves after incorporating date palm midrib particles and fibers was not considered for the analysis. The tensile and compressive strength values of: σₜ=34.33 MPa and σ_{c}=106.00 MPa were specified for the epoxy matrix with silica sand and σₜ=52 MPa and σ_{c}=28 MPa for date palm midrib, respectively, based on preliminary experimental tests and literature data [See: Date Palm Fiber Composites, Date Palm Fiber Composites (2020, incorporated herein by reference in its entirety.]. Since mesh density influences the calculation accuracy, the numerical results were carefully examined to ensure simulation convergence over the RVE geometry. The homogenization and structural analysis aided in predicting the most optimal design of the proposed composite. The modified rule of mixture equations for both particulate and short fiber composite (in Eq. (1) and Eq. (2)) presented in the previous work [See: H. Ibrahim, M. Farag, H. Megahed, S. Mehanny, Characteristics of starch-based biodegradable composites reinforced with date palm and flax fibers, Carbohydrate Polymers 101 (2014) 111-9; K. Srinivas, M. S. Bhagyashekar, Prediction of Mechanical properties of Epoxy composites containing mono and hybrids particulate fillers., IOP Conf Ser.: Mater. Sci. Eng. 1189 (2021) 012003 incorporated herein by reference in their entirety.] was also employed to predict the effective elastic modulus and compressive strength of the epoxy, silica sand and date palm midrib grout specimens. This approach entails knowing the compressive strength of the base grout composite without any waste, along with information on the weight fraction of the waste materials as given in Eq. (1) and Eq. (2).

$${E}_{c} = {E}_{m} {V}_{m} + {E}_{f} {V}_{f} \qquad ( 1 )$$

$${σ}_{c} = \{ \begin{matrix}{σ}_{m} {W}_{m} \pm \frac{{σ}_{f} {W}_{f}}{a + ( {W}_{f} - 1 ) β} & for particulate \\ {σ}_{m} {W}_{m} \pm \frac{1 - {L}_{c}}{L} {σ}_{f} {W}_{f} & for short fibre\end{matrix} \qquad ( 2 )$$

where, E is the elastic modulus, V is a volume fraction, W is a weight fraction, α=2 and β=0.1 are material constants,

$${L}_{c} = \frac{d}{2 τ} {σ}_{c - filler}$$

is a characteristic length of fiber, L is the average fiber length, d is the fiber diameter, T is the shear strength of the fiber/matrix interface, and m and f designate matrix and filler, respectively. Moreover, when the filler has a higher strength than the matrix, the positive sign should be used in the strength equations, and vice versa.

### Example 2: Experimental Methods and Composite Development

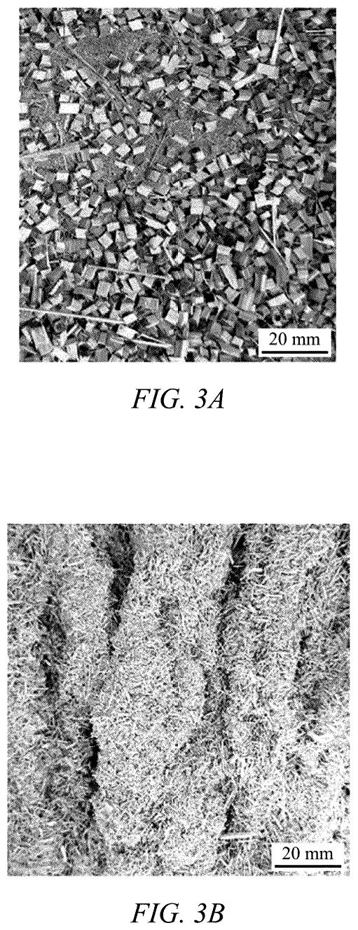

The date palm midribs were sourced from palm tree farms in the Al Ahsa region and were acquired by harvesting them once the palm trees had reached the end of their life cycle or through regular periodic trimming. To facilitate their subsequent processing, the collected date palm midribs were carefully dried to eliminate moisture content. The date palm midribs were finely cut into smaller, approximately 1 mm-long segments. The midrib fibers were obtained by processing a portion of the cut midribs using an electric blender, as shown in FIG. 3A and FIG. 3B. FIG. 3A shows date palm midribs used in epoxy date palm (EDP) composites and FIG. 3B shows date palm midrib fibers used in epoxy fiber date palm (EFDP) composites. Initial chemical pretreatment of date palm midribs was omitted due to time constraints related to the curing process of the grout specimens, logistical challenges in acquiring sufficient chemicals, and the need for a cost comparison. The decision aimed to evaluate large-scale/industrial production feasibility without additional complexity.

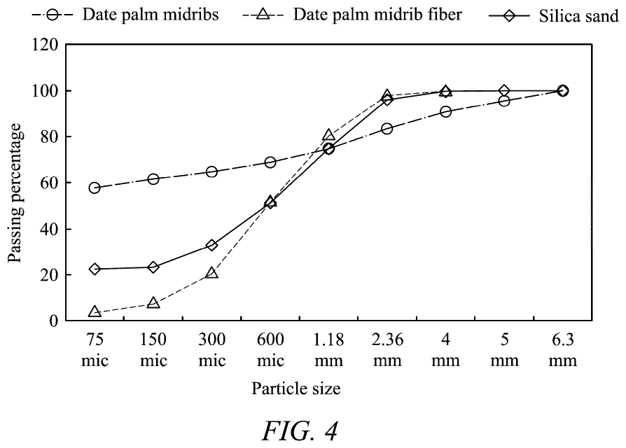

The epoxy grout employed in the present disclosure includes three key components: epoxy resin, hardener, and silica sand. The particle size distribution of the silica sand employed in the reference grout specimen falls within 75 microns to 6.3 mm, as shown in FIG. 4. The detailed specifications and geometrical dimensions of the tested blocks are provided in Table 1.

TABLE 1
Summary of the experimental tests conducted

| Tests | Standards | Specimen dimension | Geometry |
|---|---|---|---|
| Compressive | ASTM C579 | 50 mm × 50 mm × 50 mm | Cube |
| Flexural | ASTM C580 | 160 mm × 4 mm × 4 mm | Rectangular |
| | | | prism |

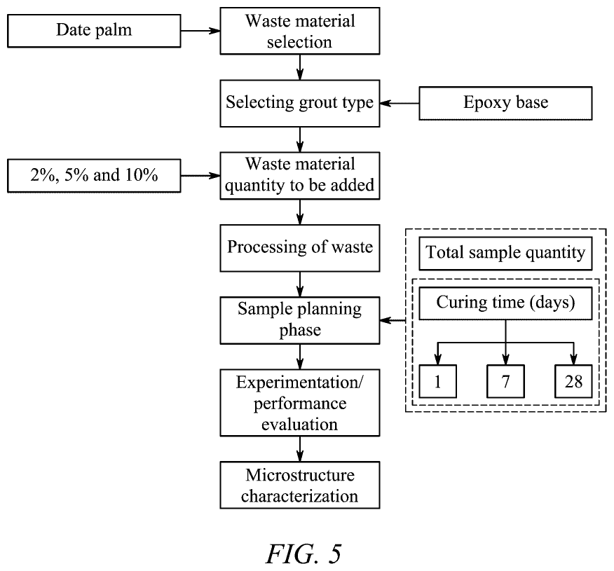

To compare the test block strengths with that of the benchmark data provided by the process industry practices handbook [See: Sika, Sikadur®-42 MP SG, Sika Group, Saudi Arabia, 2018 (accessed Jan. 1, 2024; P. Mendis, Commercial Applications and Property Requirements for Epoxies in Construction, (1985), incorporated herein by reference in its entirety] which describes grout specimens with the geometrical dimensions (i.e., cube and rectangular prims samples as provided in Table 1) and varying waste percentages were made. The block dimensions conform to the specifications provided in the ASTM C579 and C580 standards for testing grouting materials. The prepared specimens were assessed for finish, homogeneity, structural integrity of the final specimen, ease of production, and proper setting of the final grout. Based on practical considerations and simulation data obtained from computational simulations, 2% w %, 5% w % and 10% w % of date palm waste were chosen to replace silica sand. Specimens were named epoxy date palm (EDP) and epoxy fiber date palm (EFDP) for simplicity. EDP2, EDP5, EDP10, EFDP2, EFDP5, and EFDP10 denoted grout compositions with respective weight percentages of date palm waste. The epoxy-to-hardener ratio remained 5:1, while silica sand was adjusted depending on the weight fraction W_{f} of the date palm waste material added during grout synthesis. The testing procedure included determining the compressive strength of epoxy grout with date palm waste at curing times of 1, 7, and 28 days, followed by flexural testing at 28 days. All trials entailed testing three weight fractions W_{f} of specimens for each grout mixture and at the previously indicated curing times. Additionally, a separate reference epoxy grout, devoid of any waste material, served as a point of reference for the comparative assessment of mechanical properties between the two distinct grout specimens. The research methodology, outlining the experimental approach, is depicted in FIG. 5.

Compressive testing on cubic samples (see: 1300 kN compression machines, manufactured by Matest, Treviolo, Italy, incorporated herein by reference in its entirety) was performed at a loading rate of 1.5 kN/s. During compression testing, the samples were put between two metal plates if the compression equipment, and a load was applied to any one face of the cubic specimen. The compressive strength was computed using the following: σ_{c}=P_{c}/A, where: σ_{c} is the compressive strength, P_{c} is the maximum applied compressive load, and A is the cross-sectional area. Flexural testing of the rectangular prism samples was carried out (see: Instron 2810-182,100 kN Flexure Fixture, Norwood, Massachusetts, United States of America) at a 2 mm/min loading rate to obtain the flexural properties. The flexural strength was measured using the three-point bending method, and the flexural strength is calculated from:

$${σ}_{f} = 1.5 ( \frac{Pl}{{bd}^{2}} ) ,$$

where: σ_{f} is the flexural strength, b and d are the weight and thickness of the sample, P is the maximum load applied on the flexural test, and l is the distance between the carrying rollers.

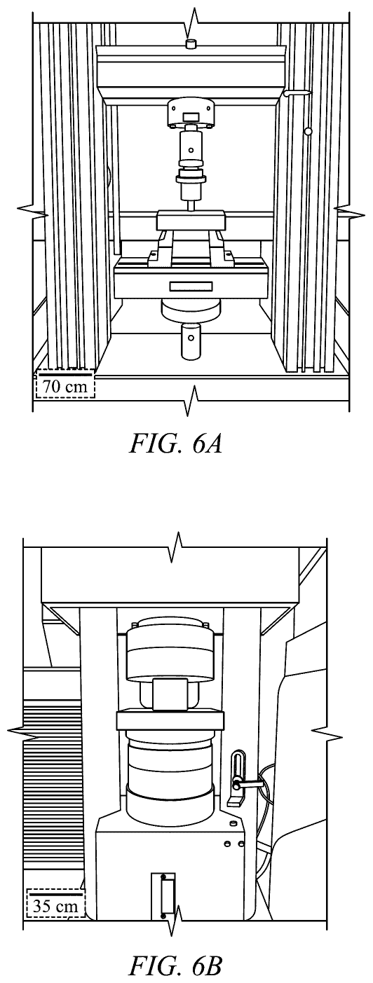

FIGS. 6A and 6B depict the flexural and compression testing of grout specimens. The compression and flexural testing of the blocks was conducted according to the ASTM C579 and C580 standards as specified in Table 1. A larger sample was not used for the current study to limit the quantity of date palm midrib waste needed to make the testing samples and adhere to the industrial standard for testing grout materials according to ASTM standards 579 and 580.

The densities of the various grout samples were determined using the weight divided-by-volume method. A four-decimal point scale was used to measure the weight of each sample accurately. Since the date palm midrib material is mainly embedded within the epoxy-based matrix and some samples did not have perfect shapes, the volume was calculated using the Archimedes principle via the water displacement method. A relative porosity was determined using the density difference between the reference sample and the composite samples containing the date palm midrib waste rather than measuring the absolute porosity fraction within each synthesized grout. Microscopic examination and the relative porosity fraction were utilized to evaluate the effects of adding date palm midrib waste to the epoxy-based grout samples. Scanning electron microscopy was conducted (SEM, Jeol JSM 6460, Japan) to examine the morphology of the modified grout specimens and date palm midrib fibers. Furthermore, the composition of the grout specimens was determined using energy dispersive x-ray spectroscopy (EDS, Oxford INCA instrument, UK). Specimens were gold coated (Qurorum 150 RS, England) for 40 see within a high vacuum for a better SEM image. X-ray diffraction patterns (XRD, Rigaku ultima IV, USA) of the date palm waste and silica sand were obtained for chemical composition analysis. The XRD equipment utilized Cu radiation with a wavelength of λ=1.544 Å. For this process, powdered samples were securely placed in the machine holder and subjected to scanning across the 2θ range from 0 to 90 degrees. To gain additional insights into the failure mechanisms under compression loading conditions, optical micrographs (Olympus DSX-CB, Japan) of the grout specimens were captured for further investigation.

### Results and Discussion

The present disclosure assesses the impact of varying weight fractions W_{f} of date palm midrib waste and varying curing time on the mechanical performance of the epoxy grout composite for under-grouting applications. The incorporation of date palm waste induced substantial alterations in the mechanical and microstructural characteristics of an epoxy grout. Therefore, the microstructure and mechanical properties of the synthesized epoxy grout composites containing varying percentages (2%, 5%, and 10%) of date palm waste, specifically comprising midribs and midrib fibers, were investigated. Suitability and feasibility of the epoxy-based grout composite containing date palm midrib waste fillers was conducted, focusing on promoting sustainable materials for various industrial uses.

### Compressive Properties of the Grout Specimens

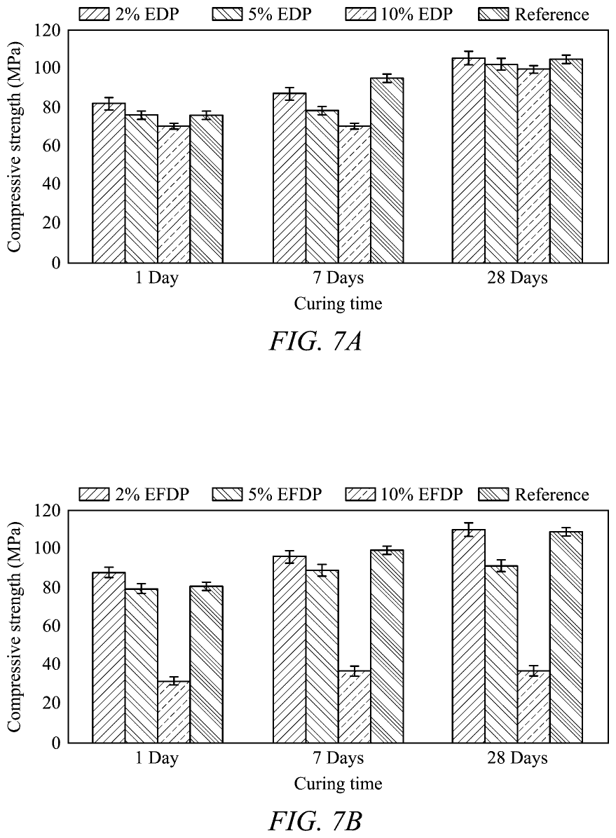

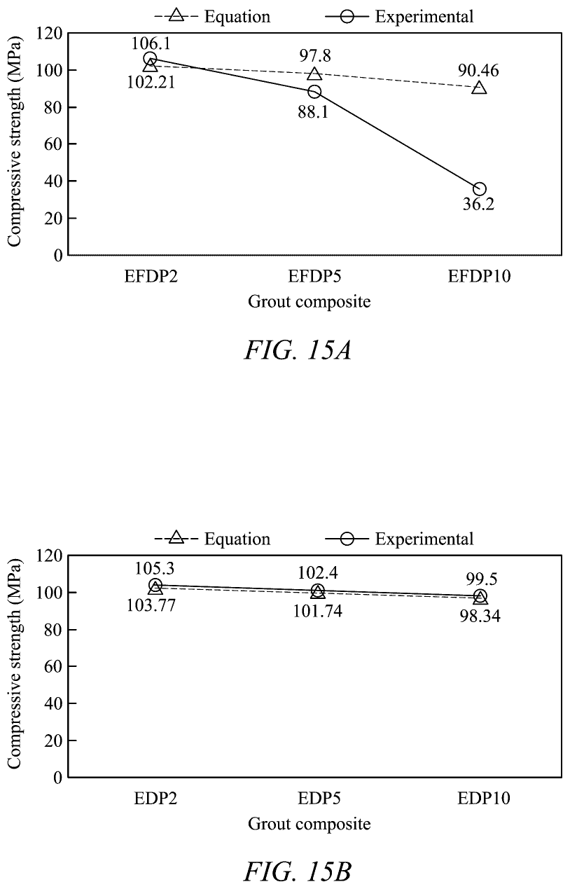

The compressive strength development of the grout specimens after a curing time of 1, 7, and 28 days is shown in FIG. 7A and FIG. 7B. The comparison of the predicted and experimental compressive strength values after a curing period of 28 days is shown in FIG. 15A and FIG. 15B. The compressive strength values derived from the rule of mixtures for both date palm midribs and midrib fibers are identical to those of the experiments, with significant deviations observed for the midrib fiber specimens. This deviation arose due to the need to incorporate the porosity fraction for the 5% and 10% EFDP composite, as noted in the density values provided in Table 2. Microscopic examination supports that the density differences, shown in Table 2, resulted from void formation in the prepared samples.

TABLE 2
Properties of the grout specimens.

| | | | | | | Modulus of |
|---|---|---|---|---|---|---|
| | Flexural | | | | | elasticity in |
| Grout | strength | Density | Compressive strength (MPa) | | | compression |
| Specimen | (MPa) | (Kg/m³) | 1 day | 7 days | 28 days | (GPa) |
| EDP2 | 30.8 ± 1.87 | 2072 ± 12.64 | 82.0 ± 1.67 | 87.0 ± 0.5 | 105.3 ± 1.01 | 13.3 ± 0.21 |
| EDP5 | 26.1 ± 1.28 | 1866 ± 15.44 | 78.0 ± 1.69 | 80.0 ± 1.88 | 102.4 ± 1.43 | 12.7 ± 0.35 |
| EDP10 | 20.8 ± 2.29 | 1688 ± 21.41 | 70.0 ± 2.4 | 70.0 ± 2.21 | 99.5 ± 1.17 | 11.4 ± 0.57 |
| EFDP2 | 29.5 ± 1.85 | 2020 ± 12.43 | 85.0 ± 1.76 | 92.8 ± 0.87 | 106.1 ± 0.75 | 9.5 ± 0.43 |
| EFDP5 | 21.3 ± 2.33 | 1918 ± 3.82 | 77.0 ± 1.30 | 86.0 ± 0.83 | 88.1 ± 1.92 | 5.2 ± 0.68 |
| EFDP10 | 9.4 ± 1.12 | 1578 ± 23.63 | 31.0 ± 1.12 | 36.0 ± 2.04 | 36.2 ± 0.95 | 3.6 ± 0.866 |
| Reference | 34.3 ± 1.45 | 2120 ± 9.12 | 76.0 ± 1.32 | 96.0 ± 1.87 | 106.0 ± 1.12 | 14.0 ± 0.31 |

This void formation is caused by the insufficient setting of the epoxy matrix, leading to poor wettability for the large volume fractions of midrib short fibers, as noted in the previous research publications. [See: H. Ibrahim, M. Farag, H. Megahed, S. Mehanny, Characteristics of starch-based biodegradable composites reinforced with date palm and flax fibers, Carbohydrate Polymers 101 (2014) 1119; I. S. M. A. Tawakkal, M. J. Cran, S. W. Bigger, Effect of kenaffibre loading and thymol concentration on the mechanical and thermal properties of PLA/kenaf/thymol composites, Industrial Crops and Products 61 (2014) 74-83, each incorporated herein by reference in its entirety]. The majority of the compressive strength development in EDP2, EDP5, and EDP10 specimens took place after a curing time of 7 days, where there was an approximate increase in value ranging from 20% to 40%. The EFDP specimens show a comparatively lower compressive strength increase, ranging between 2%-15% after the curing time of 7 days. The percentage of increase in compressive strength for the EDP2, EDP5, and EDP10 specimens was 26.41%, 34.736%, and 42.142%, respectively, between the 1-day and 28-day curing mark. Similarly, the increase in compressive strength for the EFDP2, EFDP5, and EFDP10 specimens was 24.82%, 14.54%, and 16.77%, respectively. The predominant improvement in compressive strength for EDP2, EDP5, and EDP10 specimens occurred after a 7-day curing period. In contrast, EFDP specimens exhibited a minimal increase in compressive strength after 7 days of curing, except for the EFDP2 specimen. The compressive strength of all EDP grout specimens, including EFDP2, fell within the range of 70 MPa-105 MPa. These values closely align with the 50 MPa-120 MPa range obtained by evaluating the compressive properties of five types of epoxy grouts containing inert silica and calcium fillers. [See: M. Shamsuddoha, M. M. Islam, T. Aravinthan, A. Manalo, K. tak Lau, Characterisation of mechanical and thermal properties of epoxy grouts for composite repair of steel pipelines, Materials and Design 52 (2013) 315-327, incorporated herein by reference in its entirety]. The upper range of values was limited to 105 MPa, because the date palm midribs, which are organic, are weaker than synthetic fillers like silica and calcium. Furthermore, combining fine, medium, and coarse silica powder fillers can lead to higher compressive strength values when using epoxy polymer concrete as a base matrix [See: M. Golestaneh, G. Amini, G. D. Najafpour, B. M. A. Beygi, Evaluation of Mechanical Strength of Epoxy Polymer Concrete with Silica Powder as Filler, IDOSI 9 (2010) 216-220, incorporated herein by reference in its entirety.]. This indicates a potential for enhancing compressive strength by utilizing a blend of fine, medium, and coarse fillers, rather than solely relying on midrib fillers cut into 1 mm segments.

An increase in percentage of the date palm midribs and midrib fibers caused a reduction in the compressive performance due to the decrease in the matrix homogeneity due to the introduction of date palm midribs and their fibers. Furthermore, the EFDP10 specimens had the poorest compressive strength because 10% of midrib fibers resulted in a higher interfacial (or surface) area in the grout specimens than the equivalent midrib counterparts; thus, the EFDP composite contained more inherent flaws, porosity, and weaker interfaces, which can also be proven by observing that the density of the EFDP composites was lower than that of the EDP composites due to the high porosity in the EFDP specimens. A similar observation has been reported in previous works, [See: T. Masri, H. Ounis, L. Sedira, A. Kaci, A. Benchabane, Characterization of new composite material based on date palm leaflets and expanded polystyrene wastes, Construction and Building Materials 164 (2018) 410-418, incorporated herein by reference in its entirety.] where increasing the proportion and size of the reinforcement causes the composite to become lighter.

An equation was developed to predict and approximate the value of compressive strength (σ_{c}) based on the curing time in days (t) and the weight fraction W_{f} of the date palm waste, referred to as (w) in equation (3) which is expressed as:

$${σ}_{c} = \{ \begin{matrix}0.901 t - 1.441 w + 82 \text{.2676} , & for EDP specimens \\ 0.404 t - 7.76 w + 110.042 , & for EFDP specimens\end{matrix} \qquad ( 3 )$$

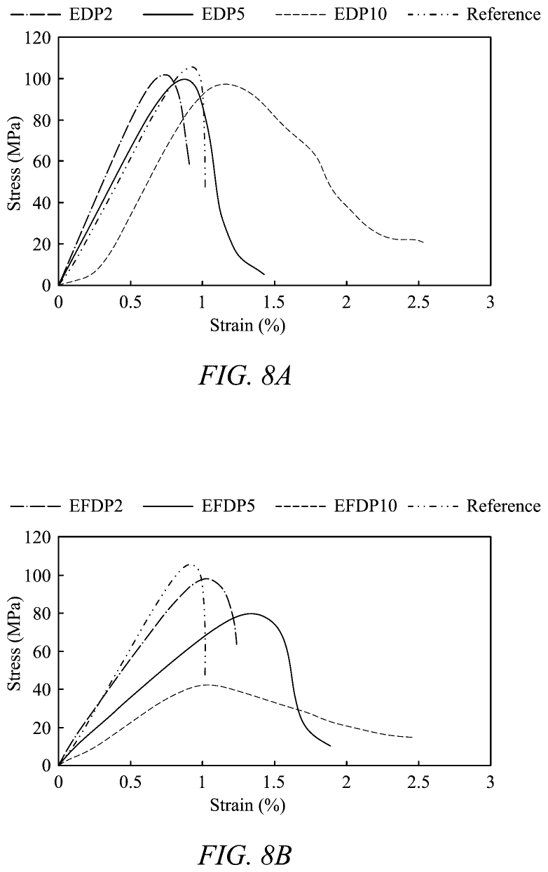

FIG. 8A and FIG. 8B illustrate the stress-strain characteristics of the EDP and EFDP grout specimens obtained after a curing period of 28 days. The EDP2, EFDP2, and reference specimens show linear elastic behavior from the initial loading phase until they reach their respective breaking points. Subsequently, the stress diminishes beyond the breaking point, resulting in an abrupt and brittle failure. Moreover, the EDP2 specimen exhibits a slightly lower strain value than the EFDP2 and reference specimen. As the date palm content increases, the grout specimens display plastic deformation and strain softening after surpassing their yield points. This signifies a decline in brittleness. Importantly, these grout specimens do not experience sudden, brittle failures. Specifically, EDP5 and EDP10 show only a marginal reduction in stress accompanied by a corresponding increase in strain. Conversely, EFDP5 and EFDP10 specimens exhibit a more substantial decrease in stress with increasing strain, attributed to increased structural inhomogeneity and increased plastic deformation, indicating a heightened degree of ductility. Table 2 presents the modulus of elasticity values in compression. Introducing date palm midrib fibers leads to a more pronounced reduction in grout stiffness compared to cases where only midribs are added. This is evident in the decrease of elastic modulus by approximately 12.634% in the EDP10 specimen compared to the reference samples. The EFDP10 specimen demonstrated a reduction in elastic modulus of up to about 72% when compared with the reference specimen. This significant reduction considerably impacts the mechanical performance of the EFDP10 grout specimen under compression due to poor stiffness value. The modulus of elasticity derived from the computational homogenization and rule of mixtures are compared to that of the compression experiments in Table 4.

TABLE 4
Estimated modulus of elasticity (GPa)
values for the epoxy grout composites

| Grout | Computational | | Rule of |
|---|---|---|---|
| composite | homogenization | Experiments | mixtures |
| EDP2 | 13.81 | 13.26 ± 0.21 | 13.73 |
| EDP5 | 13.54 | 12.69 ± 0.35 | 13.52 |
| EDP10 | 12.70 | 11.40 ± 0.57 | 13.07 |
| EFDP2 | 13.31 | 9.51 ± 0.43 | 13.73 |
| EFDP5 | 12.41 | 5.19 ± 0.68 | 13.52 |
| EFDP10 | 11.18 | 3.57 ± 0.866 | 13.07 |

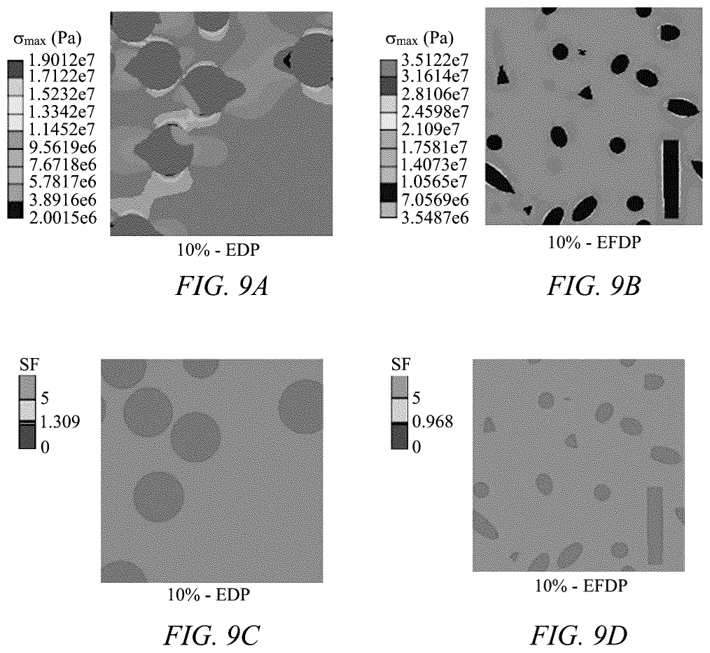

The modulus of elasticity values for the date palm midribs and midrib fibers are identical to those of experiments with major deviations predicted for the short fiber-reinforced composite specimens. The microscopic analysis confirmed that substantial void formation due to poor wettability was the cause of the large deviation in elastic modulus values observed for the 5% and 10% midrib fiber composite. Incorporating porosity as the second phase during the calculations was necessary to predict the effective properties of the highly porous samples, such as 5% and 10% midrib fiber composites. However, software limitations restrict defining multiple phases and irregular void shapes. Therefore, void inclusions that evolve after incorporating date palm midrib particles and fibers were not considered in the present disclosure. Nevertheless, the present material design calculations are deemed sufficient to predict the material properties and mechanical response of the synthesized grout composites since the differences between experimental and anticipated values are within a reasonable range. The ANSYS plot, as illustrated in FIG. 9A and FIG. 9B, indicated the formation of regions with varying stress concentrations around the interfaces of particles/fibers and the surrounding matrix. In the RVE model with the same percentage of waste, a higher presence of fibers resulted in increased interaction between date palm midrib fibers and the epoxy matrix. Consequently, the fiber composite exhibited a more significant stress concentration area than the particle RVE model. Higher stress concentration areas increase grout composite failure due to heightened internal stresses within the specimen. Increasing the percentage of waste materials in the particle and fiber RVE models could further amplify stress concentration areas, thereby increasing the risk of material failure. An assessment of the failure can be approximated through the safety factor, which is determined in ANSYS using the Mohr-Coulomb criteria for brittle materials. FIG. 9C and FIG. 9D illustrate the safety factor for the particle and short-fiber RVE model. Based on the differences between safety factor values, the probability of failure of the EFDP composites is relatively higher than that of EDP composites at higher waste material content.

### Flexural Properties of the Grout Specimens

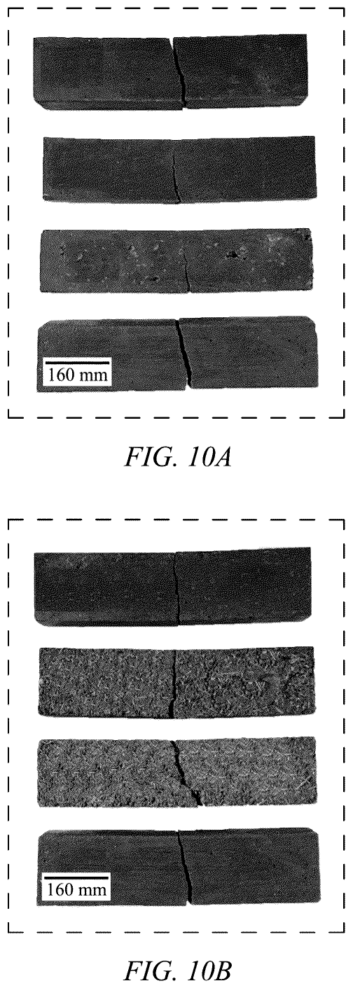

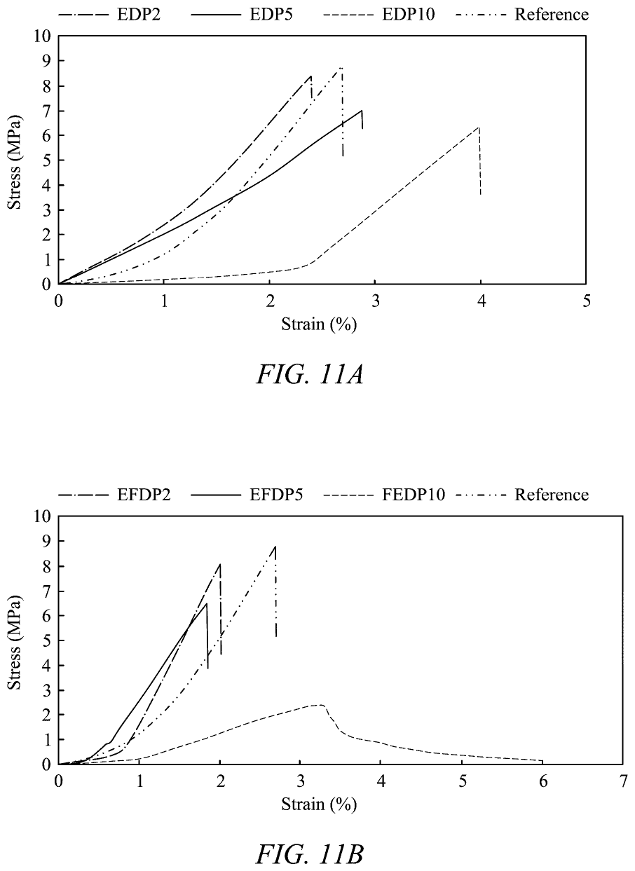

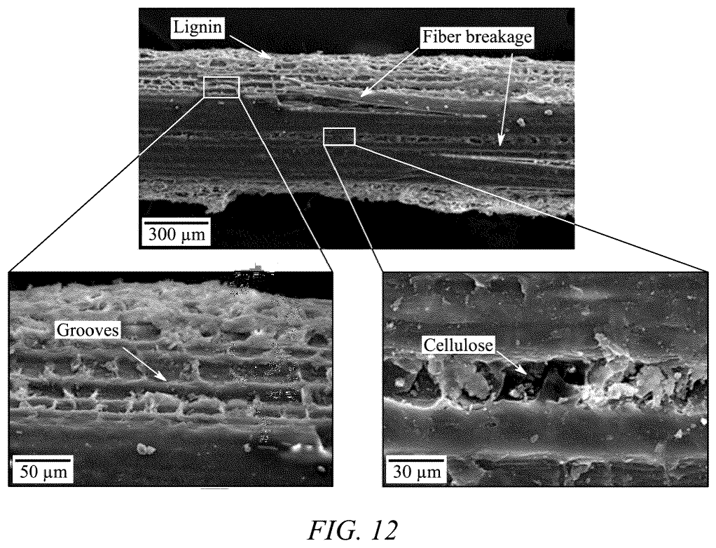

Table 2 also provided the flexural strength of the grout specimens containing 2%, 5%, and 10% date palm waste obtained after a curing period of 28 days. The failure pattern of the grout specimens and the stress-strain curves are given in FIGS. 10A-10B and FIGS. 11A-11B, respectively. The flexural strength decreased with increasing date palm % in both types of grout specimens. Compared to the reference specimen, for the EDP specimens, the flexural strength decreased by 21% as 10% midrib content is incorporated. The decrease in flexural strength of the EFDP specimens is more significant than the decrease in flexural performance of the EDP specimens. Compared to the reference specimens, this decrease in flexural strength increased to 73% for the EFDP10 specimen. As mentioned earlier, adding date palm fibers increases porosity, decreases the elastic modulus, and lowers the overall strength of the epoxy composite due to increasing interfacial area between the epoxy matrix and filler material. This is explained by considering the chemical buildup of the midribs. A recent study [See: S. Mahdavi, H. Kermanian, A. Varshoei, Comparison of mechanical properties of date palm fiber-polyethylene composite, BioResources 5 (2010) 2391-2403, incorporated herein by reference in its entirety] shows that the midribs of the date palm have a higher lignin and cellulose content than the other parts of the date palm, like petiole, trunks, and leaflets. Fibers made from these midribs can considerably reduce the density and strength of the polymer composite. As per the study [See: R. Sana, K. Foued, B. M. Yosser, J. Mounir, M. Slah, D. Bernard, Flexural properties of typha natural fiber-reinforced polyester composites, Fibers and Polymers 16 (2015) 2451-2457, incorporated herein by reference in its entirety], the epoxy composites made with midribs can reduce the flexural performance of the grout specimens due to poor bonding between the matrix and the midribs. The studies [See: K. S. Ahmed, S. Vijayarangan, C. Rajput, Mechanical Behavior of Isothalic Polyester-based Untreated Woven Jute and Glass Fabric Hybrid Composites, Http://Dx.Doi.Org/10.1177/0731684406066747 25 (2006) 1549-1569; S. N. A. Safri, M. T. H. Sultan, N. Saba, M. Jawaid, Effect of benzoyl treatment on flexural and compressive properties of sugar palm/glass fibres/epoxy hybrid composites, Polymer Testing 71 (2018) 362-369; A. Shalwan, B. F. Yousif Influence of date palm fibre and graphite filler on mechanical and wear characteristics of epoxy composites, Materials & Design 59 (2014) 264-273, each incorporated herein by reference in their entirety] also concluded that the strength of the composite would depend primarily on the matrix. Therefore, as the fiber content increases beyond a certain limit, the mechanical properties will degrade considerably due to increased non-homogeneity and poor adhesion between the epoxy matrix and date palm fibers.

The stress-strain curves of the EDP specimens showed that all the specimens fail after crossing the linear elastic range. For the EDP5 and EDP10 specimens, there is a gradual increase in strain until it reaches the linear elastic range, showing the ability of the date palm midribs to resist crack propagation. The failure stress decreased with an increase in date palm midrib content. The grout specimens immediately failed after crossing the failure stress threshold caused by the subsequent crack initiation from the middle of the specimen. The EFDP2 and EFDP5 specimens show stress-strain curves similar to the reference specimen, with the failure and crack propagation occurring immediately after the stress crosses the linear elastic region. However, the development of EFDP10 stress-strain curves is much slower, with a significantly lowered maximum stress failure limit and a decrease in the slope of the curves. This curve exhibits the highest strain values among all the EFDP and EDP specimens. The stress gradually reduces after the failure point, with the grout specimens showing significant visible deformation and a reduced tendency for brittle failure until it reaches close to 0. At this point, the curve remains as the stress continuously reduces with increasing strain till it reaches 0. A recent study [See: V. Fiore, G. Di Bella, A. Valenza, The effect of alkaline treatment on mechanical properties of kenaf fibers and their epoxy composites, Composites Part B: Engineering 68 (2015) 14-21, incorporated herein by reference in its entirety] investigated the effects of using kenaf fibers with epoxy composites. The flexural stress-strain curves showed similarities in how the stress after failure falls to 0 with increasing strain values. The study [See: A. Akhzeroun, A. Semcha, A. Bezazi, H. Boumediri, P. N. B. Reis, F. Scarpa, Development and characterization of a new sustainable composite reinforced with date palm stems for rehabilitation and reconstruction of earthen built heritage, Composite Structures 316 (2023) 117015, incorporated herein by reference in its entirety] evaluated the effects of date palm stems (DPS) on developing a new composite material. A similar stress-strain curve behavior was found with the UR-CEB composite, showing the highest degree of similarity with the EFDP10 specimen. The behavior of the EFDP10 specimen can also be correlated to results obtained by the study [See: T. Masri, H. Ounis, L. Sedira, A. Kaci, A. Benchabane, Characterization of new composite material based on date palm leaflets and expanded polystyrene wastes, Construction and Building Materials 164 (2018) 410-418, incorporated herein by reference in its entirety], in which the stress-strain curves obtained after increasing the sizes of date palm leaflets reinforcements change the failure mechanism from brittle to ductile. Therefore, the failure pattern of the EDP grout specimens showed that all the specimens failed in a brittle manner, with the EDP5 and EDP10 specimens not fracturing completely. The fractured parts in these specimens are likely held together by the date palm midribs, which appear to stop further propagation of cracks present in the direction of the loading. The failure pattern of the grout specimens shows that an increase in midrib fiber content from 2% to 10% reduces the brittle nature of the grout specimens. The crack pattern in the EFDP10 specimens does not follow a straight path but is affected by the midrib fibers in the crack propagation direction.

### Scanning Electron Microscopy (SEM)

The surface of date palm midrib fibers, as illustrated in FIG. 12, displays groove-like features made up of ordered fibrils. This structural characteristic is believed to enhance bonding between the epoxy matrix and the date palm midrib fibers. A substantial portion of the outer surface of the fibers is enveloped by lignin, which is further described in the corresponding magnified image. This internal examination of date palm fibers reveals a composition predominantly comprised of cellulose. This cellulose content within the midrib fibers accounts for their remarkable porosity. Additionally, the images capture the high degree of surface roughness that characterizes date palm midrib fibers, a feature that can contribute to greater fiber breakage sites.

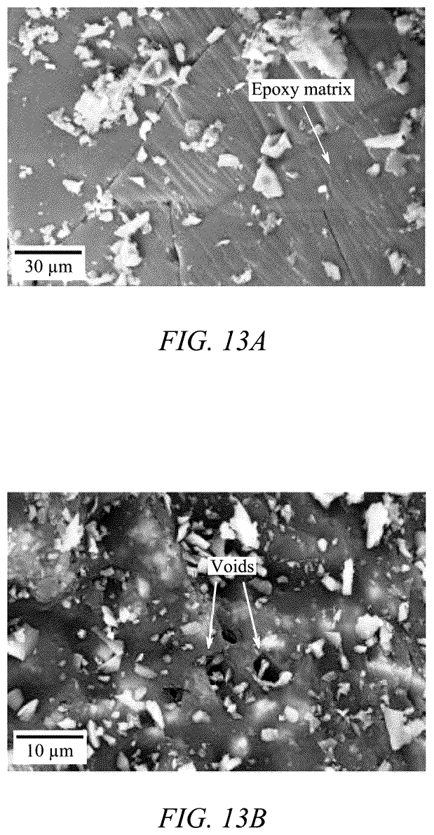

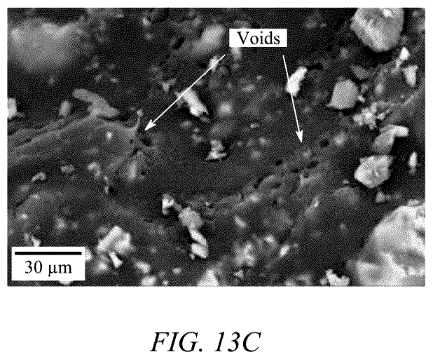

FIG. 13A, FIG. 13B, and FIG. 13C illustrate the morphological characteristics of grout specimens, including those containing 2% and 5% date palm midrib fibers, in comparison to the standard epoxy. In FIG. 13A, the surface of the standard epoxy grout exhibits a smooth exterior, marked by multiple cracks across the matrix, indicative of the brittle nature of the epoxy matrix. The grout specimens that incorporate 2% date palm fibers, as depicted in FIG. 13B, reveal a transformation in the texture of the epoxy matrix, taking on a wavy appearance. This is accompanied by a reduction in brittleness and an increased presence of voids compared to the reference specimen. This structural change does not significantly affect compressive strength when compared with the reference specimen but provides a readily apparent decrease in flexural strength. As the midrib fiber content is increased to 10%, the surface of the epoxy matrix, as seen in FIG. 13C, becomes progressively wavier and exhibits coarser features. The surface of the epoxy matrix also shows a greater accumulation of voids compared to the reference and EFDP2 specimens. Consequently, there is a significant decrease in the brittleness of the epoxy matrix, increasing the ductile characteristics. This shift towards ductility is responsible for the reduced mechanical performance observed in the EFDP10 grout specimens under both compression and flexure, evident in the stress-strain behaviour and modulus of elasticity values.

### X-Ray Diffraction Analysis

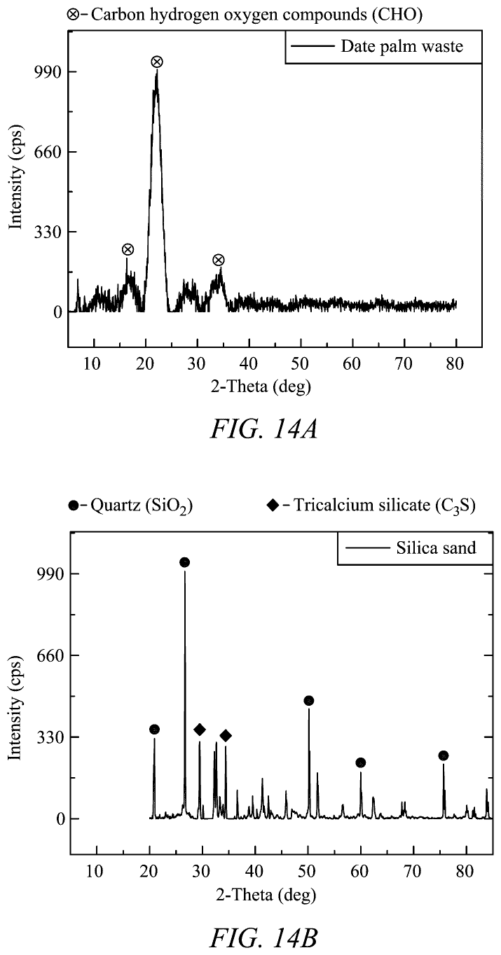

Given the organic composition of date palm midrib fibers, comprising lignin, hemicellulose, and cellulose, primarily hydrocarbon polymers, the XRD pattern of date palm waste prominently displays carbon-hydrogen-oxygen (CHO) compounds, as illustrated in FIG. 14A. The XRD peaks in this pattern are characterized by a broad and diffuse distribution, which indicates the amorphous nature of date palm waste. Hemicellulose is noteworthy for its higher hydroxyl group content, which enhances its capacity for water absorption and adhesion to cellulose and lignin groups [See: M. Golestaneh, G. Amini, G. D. Najafpour, B. M. A. Beygi, Evaluation of Mechanical Strength of Epoxy Polymer Concrete with Silica Powder as Filler, IDOSI9 (2010) 216-220, incorporated herein by reference in its entirety]. In FIG. 14B, the XRD pattern of silica sand is presented. The high-intensity peaks in this pattern are predominantly associated with quartz and exhibit a narrow profile across the given diffraction angles, suggesting that the silica sand particles possess a relatively ordered and larger structure, contributing to the sharpness and heightened intensity of the peaks. The most prominent peak for quartz is observed at 26.68°, followed by secondary and tertiary peaks at 50.2° and 20.92°, respectively. Additionally, the XRD analysis reveals the presence of alite (Ca₃O₅Si), more commonly referred to as tricalcium silicate (C₃S), a compound typically found in materials containing ordinary Portland cement (OPC). Alite is characterized by peaks at 29.48° and 34.4°.

### Optical Microscopy of Fractured Surfaces

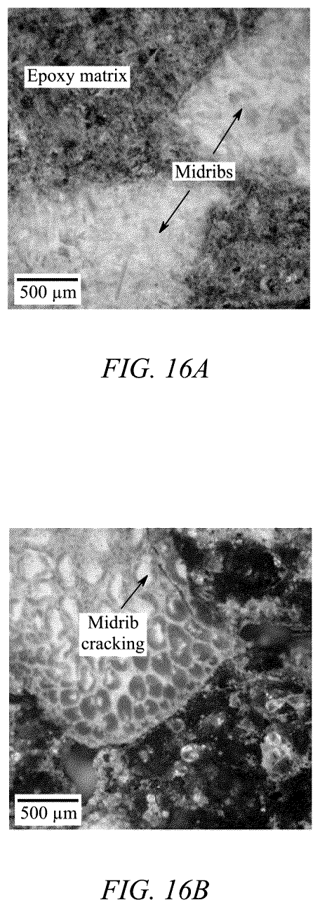

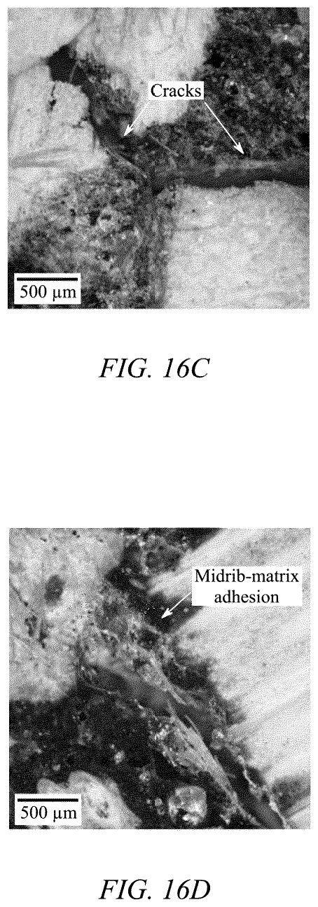

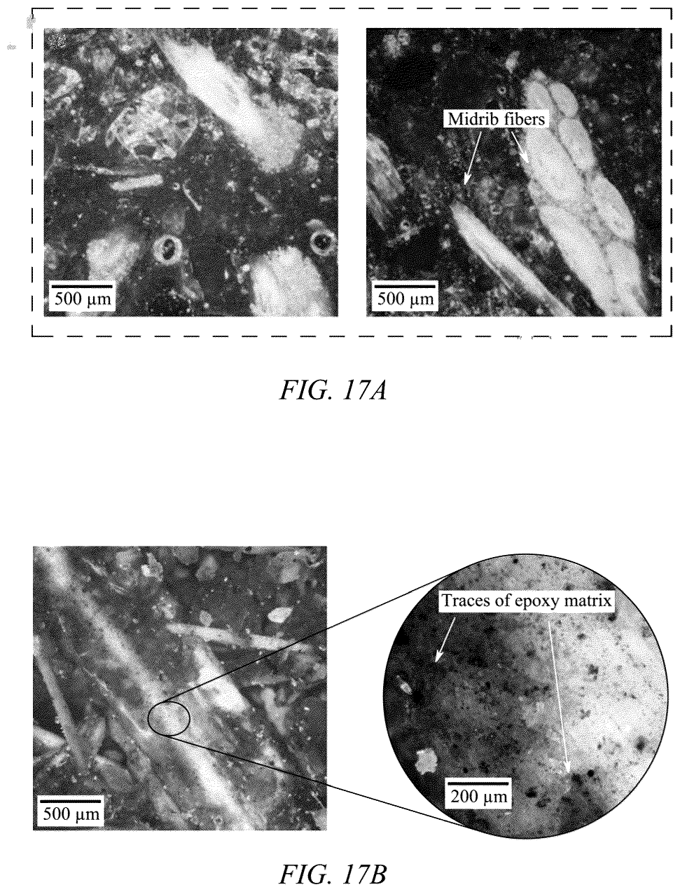

Optical micrographs of the grout specimens (EDP and EFDP) subjected to failure under compressive loading were investigated to understand the internal structure and fracture behavior of the grout specimens, as depicted by FIGS. 16A-16D and FIGS. 17A-17B. FIG. 16A illustrates the distribution of date palm midribs within the epoxy matrix of the EDP specimens. The interface bonding between the date palm midribs and the epoxy matrix appears seamless, indicating satisfactory adhesion and proper mixing, ensuring complete coverage of the midribs. Under compression loading, cracking is observed, which is found to propagate in two distinct manners: firstly, along the edges of date palm midribs, and secondly, through the midribs themselves. The former crack propagation type is more prevalent in midribs with uniform, well-defined rectangular shapes, as evident in FIG. 16A. When cracks propagate along the midrib edges, it often leads to complete separation of the midrib from the epoxy matrix. In some instances, where the epoxy matrix slightly penetrates the inner structure of the date palm midrib, the crack follows through the matrix rather than causing midrib detachment. This suggests that adhesion between the epoxy matrix and the midrib weakens under compressive loading. Conversely, the latter crack propagation type primarily occurs in midribs with irregular shapes, as depicted in FIG. 16B, FIG. 16C, and FIG. 16D. Irregularly shaped midribs also exhibit increased cracking along their edges, in addition to cracking within the midribs. These cracking phenomena are observed consistently in all the EFDP specimens, regardless of midrib content. An increase in the proportion of date palm midribs from 2% to 10% leads to a higher occurrence of such cracks within the epoxy grout specimens due to the reduced availability of the surrounding epoxy matrix and larger-sized date palm midribs.

FIG. 17A shows the optical micrographs of the EFDP2 specimens for the epoxy grout containing date palm midrib fibers. The smaller-sized midrib fibers have a better degree of adhesion with the epoxy matrix than the bigger midrib fibers, implying that smaller fibers can offer greater bond strength between the epoxy matrix and the midrib fibers. This can be seen by the compressive strength data shown in FIG. 7A and FIG. 7B, where the compressive strength of the EFDP2 specimens is higher than the EDP10 specimens. The flexural strength values remain almost similar, indicating that this improvement might be limited to only loads applied due to compression. Furthermore, an increase in midrib fibers from 2% to 10% significantly increases the gaps/voids within the matrix, as shown in FIG. 17B. The higher presence of voids is believed to be caused by the insufficient setting of the epoxy matrix, as most of the EFDP10 specimen consists of fibers rather than the matrix itself, which are distributed randomly within the grout specimen. The combination of the epoxy resin and the silica filler during the synthesis is insufficient to thoroughly coat/wet the midrib fibers. This results in voids and a highly non-homogeneous epoxy matrix structure. This poor behavior between the matrix and the fibers also significantly degrades compressive and flexural performance. The EFDP10 specimen shows extremely poor compressive and flexural strengths compared to the EDP2 specimen. For the same percentage waste, the interfacial (surface) area for contact between the midrib fiber and epoxy in the grout specimens will be more than that of the bigger midribs. In a study [See: I. S. M. A. Tawakkal, M. J. Cran, S. W. Bigger, Effect of kenaffibre loading and thymol concentration on the mechanical and thermal properties of PLA/kenaf/thymol composites, Industrial Crops and Products 61 (2014) 74-83, incorporated herein by reference in its entirety J, it was indicated that the addition of kenaf fiber content up to 40% by weight and 10% (w/w) of thymol could result in an insufficient wetting of the fiber with the matrix and can cause a decrease in the ability of stresses to be transferred due to high fiber content. A study [See: H. Ibrahim, M. Farag, H. Megahed, S. Mehanny, Characteristics of starch-based biodegradable composites reinforced with date palm and flax fibers, Carbohydrate Polymers 101 (2014) 111-9, incorporated herein by reference in its entirety] also suggested that increasing the wt % of the fibers increased the porosity of the composites, which was caused by the insufficient amount of matrix to cover the fibers. However, it is essential to remember that the midrib fibers in the present disclosure are larger, which causes a lower total fiber volume content to exhibit behaviour similar to that of composites with a higher content of fibers with smaller sizes.

### Assessing the Performance of the Newly Developed Grout Specimens

Using the grout mixtures modified with date palm wastes offers renewability, sustainability, and economic benefits. The typical properties of epoxy grouts suitable for practical applications are shown in Table 3.

TABLE 3
Properties of epoxy grouts for practical applications

| | Compressive | Tensile | Bond |
|---|---|---|---|
| | strength | Strength | Strength |
| Application | (MPa) | (MPa) | (MPa) |
| Bonding dissimilar | — | 10-55 | 7-35 |
| materials | | | |
| Concrete crack repair | 41-97 | 14-55 | 14-35 |
| Structural rehabilitation | 83-97 | 28-48 | 28-41 |
| Foundation and heavy | ≥97 from Ref. [A] | | 15-28 |
| machinery applications | ≥80 from Ref. [B] | | |

Ref A: P. Mendis, Commercial Applications and Property Requirements for Epoxies in Construction, (1985)
Ref B: STS03601 - Epoxy Grout Specification, Pdfcoffee.Com (n.d.). https://pdfcoffee.com/sts03601-epoxy-grout-specification-pdf-free.html (accessed Dec. 31, 2023)

Under-grouting applications typically involve predominant compressive loading exerted on the epoxy grout surfaces. Based on Table 3 and the results obtained in the present disclosure, EDP2 and EDP5 specimens can be used for structural rehabilitation, foundation, and heavy machinery applications after a curing time of 28 days. The EDP10 specimen achieves a slightly higher value than the limit imposed by the heavy machinery criteria. Thus, for safety considerations, the EDP10 specimen should be limited for use in structural rehabilitation criteria after a curing time of 28 days. Among the EFDP specimens, only the EFDP2 specimens cured for 28 days can be used for foundation and heavy machinery applications. The EFDP2 and the EFDP5 specimens can be used for structural rehabilitation after crossing a curing time of 7 days. The EFDP10 specimens have the poorest performance among the synthesized grout specimens and have limited practical application. Compressive loading is the predominant force acting upon grout materials, particularly in their implementation, within the base of foundations, and in the support of heavy machinery. These scenarios incorporate various application areas, including their utilization as a solid base for machine beds, industrial equipment, and foundation base plates. Drawing insights from the required properties presented in Table 3 and the results of compression tests, it is evident that the grout mixtures incorporating between two and ten weight percent of date palm waste meet the requirements for foundation and heavy machinery applications, when a compressive strength exceeding 80-97 MPa is the desired criterion. Moreover, these grout formulations hold promise for structural rehabilitation applications, especially in conditions marked by compressive loading. There is also a high potential to replace the reference grout specimens with those containing date palm waste in cases where production costs for the latter are more favorable. This substitution offers a cost-effective alternative and encourages the responsible utilization of waste materials sourced from landfills and demolition sites, thereby contributing to the commendable practice of waste reduction and heightened recycling efforts.

A first embodiment describes a grout composition including an epoxy resin, a hardener in a ratio of about one part hardener to about five parts epoxy resin, a first filler consisting of a silica sand having a density in a range of about 2000 kg/m³ to about 2300 kg/m³, and a second filler comprising a weight fraction W_{f} of about 2 wt % to about 10 wt % of date palm waste material having a density in a range of 85 kg/m³ to 890 kg/m³, wherein wt % is a ratio of a weight of the second filler to a total weight of the grout composition.

In an aspect, the date palm waste material of the second filler consists of date palm midrib particulates having an average diameter of about 5 mm, wherein a compressive strength σ_{c} of the grout composition is given by:

$${σ}_{c} = {σ}_{m} {W}_{m} \pm {σ}_{f} {W}_{f} / ( α + ( {W}_{f} - 1 ) β )$$

where σₘ is a compressive strength of a matrix of the epoxy, the hardener, and the silica sand, Wₘ is a weight fraction of the matrix, W_{f} is a weight fraction of the date palm midrib particulates, α=2, β=0.1 and σ_{f} is a compressive strength of the date palm midrib particulates, wherein the compressive strength σ_{c} of the grout composition is in a range of about 70 MPa to about 105 MPa.

In an aspect, the compressive strength σ_{c} of the grout composition comprising date palm midribs with respect to a curing time in days t is given by:

$${σ}_{c} = 0.901 t - 1.441 {W}_{f} + 82.2676 ,$$

wherein the compressive strength σ_{c} of the grout composition is in a range of about 70 MPa to about 80 MPa after a curing time of one day and the compressive strength σ_{c} of the grout composition is in a range of about 99.5 MPa to about 105 MPa after a curing time of 28 days.

In an aspect, the weight fraction W_{f} of the date palm midrib particulates is about 2 wt %.

In an aspect, the epoxy resin is present in a weight fraction Wₑ of about 11.9 wt %, the hardener is present in a weight fraction Wₕ of about 2.3 wt % and the silica sand is present in a weight fraction Wₛ of about 83.3 wt %.

In an aspect, the compressive strength σ_{c} of the grout composition is about 105.3 MPa and a flexural strength is about 30.78 MPa after a curing time of 28 days.

In an aspect, the weight fraction W_{f} of the date palm midrib particulates is about 5 wt %.

In an aspect, the epoxy resin is present in a weight fraction Wₑ of about 11.9 wt %, the hardener is present in a weight fraction Wₕ of about 2.3 wt % and the silica sand is present in a weight fraction Wₛ of about 80.75 wt %.

In an aspect, the compressive strength σ_{c} of the grout composition is about 102.4 MPa and a flexural strength is about 26.14 MPa after a curing time of 28 days.

In an aspect, the date palm waste material of the second filler consists of date palm midrib fibers having an average fiber diameter of about 0.1 mm, wherein an elastic modulus E_{c} of the grout composition is given by:

$${E}_{c} = {E}_{m} {V}_{m} + {E}_{f} {V}_{f} ,$$

where Eₘ is an elastic modulus of a matrix of the epoxy, hardener, and silica sand, Vₘ is a volume fraction of the matrix of the epoxy, hardener and silica sand, E_{f} is an elastic modulus of the date palm midrib fibers, and V_{f} is a volume fraction of the date palm midrib fibers, wherein the modulus of elasticity E_{c} is in a range of about 3.6 GPa to about 9.5 GPa.

In an aspect, the compressive strength σ_{c} of the grout composition is given by:

$${σ}_{c} = {σ}_{m} {W}_{m} \pm ( ( 1 - {L}_{c} ) / L ) {σ}_{f} {W}_{f} ,$$

where σₘ is a compressive strength of a matrix of the epoxy, hardener, and silica sand, Wₘ is a weight fraction of the matrix, W_{f} is the weight fraction of the date palm midrib fibers, α=2, β=0.1, σ_{f} is a compressive strength of the date palm midrib fibers, L_{c}=(d/2τ) σ_{c-filler} is a characteristic length of fiber, L is an average length of the date palm midrib fibers, d is an average diameter of the date palm midrib fibers, and T is a shear strength of an interface of the matrix with the date palm midrib fibers, wherein the compressive strength σ_{c} of the grout composition is in a range of about 31 MPa to about 106 MPa.

In an aspect, the compressive strength ac of the grout composition comprising midrib fibers with respect to a curing time in days t is given by:

$${σ}_{c} = 0.404 t - 7.760 {W}_{f} + 110.042 ,$$

wherein the compressive strength σ_{c} of the grout composition is in a range of about 31 MPa to about 88 MPa after a curing time of one day and the compressive strength σ_{c} of the grout composition is in a range of about 36 MPa to about 99.5 MPa after a curing time of 28 days.

In an aspect, the weight fraction W_{f} of the date palm midrib fibers is about 2 wt %.

In an aspect, the epoxy resin is present in a weight fraction Wₑ of about 11.9 wt %, the hardener is present in a weight fraction Wₕ of about 2.3 wt %, and the silica sand is present in a weight fraction Wₛ of about 83.3 wt %.

In an aspect, the compressive strength σ_{c} of the grout composition is about 106.10 MPa and a flexural strength is about 29.45 MPa after a curing time of 28 days.

In an aspect, the weight fraction W_{f} of the date palm midrib fibers is about 5 wt %.

In an aspect, the epoxy resin is present in a weight fraction Wₑ of about 11.9 wt %, the hardener is present in a weight fraction Wₕ of about 2.3 wt % and the silica sand is present in a weight fraction Wₛ of about 80.75 wt %.

In an aspect, the compressive strength σ_{c} of the grout composition is about 88.10 MPa and a flexural strength is about 21.26 MPa after a curing time of 28 days.

In an aspect, the silica sand has a density of about 2120 kg/m³.

A second embodiment describes a method 100 of making a grout composition. The method 100 includes compounding, with a stirrer, a base composition by mixing an epoxy resin in a weight fraction of about 11.9 wt %, a hardener in a ratio of about one part hardener to about five parts epoxy resin and a first filler consisting of a silica sand having a density in a range of about 2000 kg/m³ to about 2300 kg/m³, and mixing, with the stirrer, a second filler comprising a weight fraction W_{f} of about 2 wt % to about 10 wt % of date palm waste material having a density in a range comprising 85 kg/m³ to 890 kg/m³ into the base composition, wherein the date palm waste material is composed of one of date palm midrib particulates in a weight fraction of about 2 wt %, date palm midrib particulates in a weight fraction of about 5 wt %, date palm midrib fibers in a weight fraction of about 2 wt %, and date palm midrib fibers in a weight fraction of about 5 wt %.

The present disclosure relates to synthesis, characterization, and performance evaluation of the grout composition developed from epoxy, silica sand, and date palm waste materials is disclosed. A portion of the silica sand in the epoxy grout specimen was replaced by a specified percentage (2%, 5%, and 10%) of the date palm waste. Compression testing was conducted on all the grout compositions, followed by flexural testing. Characterization studies were carried out using high-resolution optical microscopy, XRD, and SEM.

According to the present disclosure, the highest compressive strength values are achieved by EDP2 and EFDP2 specimens, reaching up to 105.3 MPa and 106.1 MPa, respectively. Higher percentages of date palm waste result in diminished grout performance, potentially attributed to decreased matrix homogeneity. The EFDP10 specimen, featuring 10% midrib fibers, displays the weakest compressive strength at 36.2 MPa. Further, increasing the percentage of date palm waste in epoxy composites decreases flexural strength. EFDP specimens exhibit a more pronounced decrease due to higher midrib fiber content, leading to poor matrix adhesion and increased void content. The high lignin and cellulose content in midribs contribute to lower composite densities and strength, while poor bonding between matrix and midribs increases the severity of this effect. Utilizing date palm waste with lower lignin content could enhance flexural properties in epoxy specimens.

Optical microscopy revealed that compressive loading of the epoxy grout compositions causes crack propagation along midrib edges and through midribs. Uniform midrib shapes lead to detachment from the matrix, while irregular shapes cause edge and internal cracking. Crack occurrence increases with midrib content, suggesting structural integrity challenges with higher proportions. EFDP specimens with higher midrib fiber percentages exhibit inadequate matrix-fiber bonding, forming large gaps and significantly decreasing mechanical performance. SEM analysis reveals that adding 2% date palm fibers to epoxy produces a wavier texture and more voids, shifting towards ductility with comparable compressive strength but decreased flexural strength. Increasing midrib fiber content to 10% further increases waviness and coarseness, reducing brittleness and accumulating more voids, leading to substantial declines in mechanical performance in both compression and flexure. Incorporating date palm waste into grout synthesis presents a promising sustainability solution. This approach reduces waste, minimizes environmental impact by diverting waste from landfills, and yields grout mixtures with satisfactory mechanical performance. The absence of chemical treatments simplifies the scalability of grout specimen preparation from laboratory to industrial scale. This scalability, achieved with minimal equipment and without specialized facilities, promises a cost-effective solution, significantly reducing the logistical and financial resources typically required for large-scale epoxy grouting of machine bases and support structures.

The epoxy grout compositions of the present disclosure may help synthesize the epoxy resin with hardener/binder reagents from recycled sources and lead to an epoxy grout composite made entirely from the recycled materials. Further, grout mixtures entirely composed of waste materials may be developed which may provide a desirable and sustainable option for various practical/industrial applications. Moreover, investigating ways to enhance the adhesion between the grout matrix and the date palm waste (through a chemical treatment) holds promise for improving mechanical properties, such as strength and modulus of elasticity, through enhanced particle bonding. The results of the present disclosure aid in understanding the practical suitability of these grout formulations for dynamic loading applications, focusing on the transmission of vibrations between machinery or equipment and the underlying grout material.

Numerous modifications and variations of the present disclosure are possible in light of the above teachings. It is therefore to be understood that within the scope of the appended claims, the invention may be practiced otherwise than as specifically described herein.

1. A grout composition, comprising:
an epoxy resin;
a hardener in a ratio of about one part hardener to about five parts epoxy resin;
a first filler consisting of a silica sand having a density in a range of about 2000 kg/m³ to about 2300 kg/m³; and
a second filler comprising a weight fraction W_{f} of about 2 wt % to about 10 wt % of date palm waste material having a density in a range of 85 kg/m³ to 890 kg/m³, wherein wt % is a ratio of a weight of the second filler to a total weight of the grout composition.

2. The grout composition of claim 1, wherein:
the date palm waste material of the second filler consists of date palm midrib particulates having an average diameter of about 5 mm,
wherein a compressive strength σ_{c} of the grout composition is given by
$${σ}_{c} = {σ}_{m} {W}_{m} \pm {σ}_{f} {W}_{f} / ( α + ( {W}_{f} - 1 ) β )$$
where σₘ is a compressive strength of a matrix of the epoxy, the hardener and the silica sand, Wₘ is a weight fraction of the matrix, α=2, β=0.1 and σ_{f} is a compressive strength of the date palm midrib particulates, wherein the compressive strength σ_{c} of the grout composition is in a range of about 70 MPa to about 105 MPa.

3. The grout composition of claim 2, wherein the compressive strength 6c of the grout composition with respect to a curing time in days t is given by:
$${σ}_{c} = 0.901 t - 1.441 {W}_{f} + 82.2676 ,$$
wherein the compressive strength σ_{c} of the grout composition is in a range of about 70 MPa to about 80 MPa after a curing time of one day and the compressive strength σ_{c} of the grout composition is in a range of about 99.5 MPa to about 105 MPa after a curing time of 28 days.

4. The grout composition of claim 2, wherein the weight fraction W_{f} of the date palm midrib particulates is about 2 wt %.

5. The grout composition of claim 4, wherein the epoxy resin is present in a weight fraction Wₑ of about 11.9 wt %, the hardener is present in a weight fraction Wₕ of about 2.3 wt % and the silica sand is present in a weight fraction Wₛ of about 83.3 wt %.

6. The grout composition of claim 5, wherein the compressive strength σ_{c} of the grout composition is about 105.3 MPa and a flexural strength is about 30.8 MPa after a curing time of 28 days.

7. The grout composition of claim 2, wherein the weight fraction W_{f} of the date palm midrib particulates is about 5 wt %.

8. The grout composition of claim 7, wherein the epoxy resin is present in a weight fraction Wₑ of about 11.9 wt %, the hardener is present in a weight fraction Wₕ of about 2.3 wt % and the silica sand is present in a weight fraction Wₛ of about 80.75 wt %.

9. The grout composition of claim 7, wherein the compressive strength σ_{c} of the grout composition is about 102.4 MPa and a flexural strength is about 26.1 MPa after a curing time of 28 days.

10. The grout composition of claim 1, wherein the date palm waste material of the second filler consists of date palm midrib fibers having an average fiber diameter of about 0.1 mm, wherein a modulus of elasticity E_{c} of the grout composition is given by
$${E}_{c} = {E}_{m} {V}_{m} + {E}_{f} {V}_{f}$$
where Eₘ is a modulus of elasticity of a matrix of the epoxy, hardener and silica sand, Vₘ is a volume fraction of the matrix of the epoxy, hardener and silica sand, E_{f} is a modulus of elasticity of the date palm midrib fibers and V_{f} is a volume fraction of the date palm midrib fibers, wherein the modulus of elasticity E_{c} is in a range of about 3.6 GPa to about 9.5 GPa.

11. The grout composition of claim 10, wherein a compressive strength σ_{c} of the grout composition is given by:
$${σ}_{c} = {σ}_{m} {W}_{m} \pm ( ( 1 - Lc ) / L ) {σ}_{f} {W}_{f}$$
where σₘ is a compressive strength of a matrix of the epoxy, hardener and silica sand, Wₘ is a weight fraction of the matrix, W_{f} is a weight fraction of the date palm midrib fibers, α=2, β=0.1, σ_{f} is a compressive strength of the date palm midrib fibers,
$${L}_{c} = \frac{d}{2 τ} {σ}_{c - filler}$$
is a characteristic length of fiber, L is an average length of the date palm midrib fibers, d is an average diameter of the date palm midrib fibers, and τ is a shear strength of an interface of the matrix with the date palm midrib fibers, wherein the compressive strength σ_{c} of the grout composition is in a range of about 31 MPa to about 106 MPa.

12. The grout composition of claim 11, wherein the compressive strength σ_{c} of the grout composition with respect to a curing time in days t is given by:
$${σ}_{c} = 0.404 t - 7.760 {W}_{f} + 110.042 ,$$
wherein the compressive strength σ_{c} of the grout composition is in a range of about 31 MPa to about 88 MPa after a curing time of one day and the compressive strength σ_{c} of the grout composition is in a range of about 36 MPa to about 99.5 MPa after a curing time of 28 days.

13. The grout composition of claim 11, wherein the weight fraction W_{f} of the date palm midrib fibers is about 2 wt %.

14. The grout composition of claim 13, wherein the epoxy resin is present in a weight fraction Wₑ of about 11.9 wt %, the hardener is present in a weight fraction Wₕ of about 2.3 wt % and the silica sand is present in a weight fraction Wₛ of about 83.3 wt %.

15. The grout composition of claim 14, wherein the compressive strength σ_{c} of the grout composition is about 106.10 MPa and a flexural strength is about 29.45 MPa after a curing time of 28 days.

16. The grout composition of claim 11, wherein the weight fraction W_{f} of the date palm midrib fibers is about 5 wt %.

17. The grout composition of claim 16, wherein the epoxy resin is present in a weight fraction Wₑ of about 11.9 wt %, the hardener is present in a weight fraction Wₕ of about 2.3 wt % and the silica sand is present in a weight fraction Wₛ of about 80.75 wt %.

18. The grout composition of claim 17, wherein the compressive strength σ_{c} of the grout composition is about 88.10 MPa and a flexural strength is about 21.3 MPa after a curing time of 28 days.

19. The grout composition of claim 1, wherein the silica sand has a density of about 2120 kg/m³.

20. A method of making a grout composition, comprising:
compounding, with a stirrer, a base composition by mixing an epoxy resin in a weight fraction of about 11.9 wt %, a hardener in a ratio of about one part hardener to about five parts epoxy resin and a first filler consisting of a silica sand having a density in a range of about 2000 kg/m³ to about 2300 kg/m³; and
mixing, with the stirrer, a second filler comprising a weight fraction W_{f} of about 2 wt % to about 10 wt % of date palm waste material having a density in a range comprising 85 kg/m³ to 890 kg/m³ into the base composition, wherein the date palm waste material is composed of one of:
date palm midrib particulates in a weight fraction of about 2 wt %,
date palm midrib particulates in a weight fraction of about 5 wt %,
date palm midrib fibers in a weight fraction of about 2 wt %, and
date palm midrib fibers in a weight fraction of about 5 wt %, wherein wt % is a ratio of a weight of the second filler to a total weight of the grout composition.
